(19) United States
(12) Patent Application Publication
(10) Pub. No.: US 2021/0086545 A1
(43) Pub. Date: Mar. 25, 2021

(54) PROCESS FOR THE PRODUCTION OF STRONGLY ADHERENT (EMBOSSED) FILMS ON FLEXIBLE SUBSTRATES

(71) Applicant: BASF SE, Ludwigshafen am Rhein (DE)

(72) Inventors: Oliver SEEGER, Ludwigshafen (DE); Michelle RICHERT, Basel (CH)

(73) Assignee: BASF SE, Ludwigshafen am Rhein (DE)

(21) Appl. No.: 17/045,703

(22) PCT Filed: Apr. 23, 2019
(86) PCT No.: PCT/EP2019/060260

§ 371 Date: Oct. 6, 2020

(30) Foreign Application Priority Data
Apr. 25, 2018 (EP) 18169190.8

(51) Int. Cl. B42D 25/425; B42D 25/324; B42D 25/351; B42D 25/355; B42D 25/373; B42D 25/369; B42D 25/364; B42D 25/382; B42D 25/465; C09D 175/14

(52) U.S. Cl. CPC B42D 25/425; B42D 25/324; B42D 25/351; B42D 25/355; B42D 25/373; B42D 25/23; B42D 25/364; B42D 25/382; B42D 25/465; C09D 175/14; B42D 25/369

(57) ABSTRACT

Processes can produce strongly adherent, particularly embossed, films on flexible substrates. Security elements may be obtained by such processes as may be security documents, e.g., comprising the security elements. By coating a flexible substrate first with a primer layer and then with an embossed film, the adherence of the embossed film to the substrate may be improved while keeping the optical performance of the embossed film.

The present invention relates to a process for the production of strongly adherent (embossed) films on flexible substrates, security elements, obtainable by the process and security documents, comprising the security elements. By coating a flexible substrate first with a primer layer and then with an embossed film the adherence of the embossed film to the substrate is improved while keeping the optical performance of the embossed film.

WO08061930 relates to a method for forming an optically variable image on a substrate comprising the steps of: A) applying a curable compound, or composition to at least a portion of the substrate; B) contacting at least a portion of the curable compound with optically variable image forming means; C) curing the curable compound and D) optionally depositing a metallic ink on at least a portion of the cured compound, wherein the optically variable image forming means comprise a) a transparent carrier, b) a transparent material which carries an optically variable image to be applied, and c) means to dry or cure a varnish.

WO12176126 relates to a method for forming a surface relief microstructure, especially an optically variable image (an optically variable device) on a paper substrate comprising the steps of:

A) applying a curable composition (varnish) to at least a portion of the frontside of the paper substrate;
B) contacting at least a portion of the curable composition with surface relief microstructure, especially optically variable image forming means;
C) curing the composition by using at least one UV lamp which is arranged on the backside of the paper substrate;
D) optionally depositing a layer of a transparent high refractive index material and/or a metallic layer on at least a portion of the cured composition, wherein the lamp having emission peak(s) in the UV-A range and preferably near VIS range and the curable composition comprises at least a photoinitiator which absorbs in the UV-A region and preferably in addition in the near VIS range.

EP1135219B1 relates to a process for the production of strongly adherent coatings on an inorganic or organic substrate that comprises

in a first step a) subjecting the inorganic or organic substrate to the action of a low-temperature plasma discharge, a corona discharge, high-energy UV radiation or electron radiation, then discontinuing the radiation or discharge;
in a further step b) under vacuum or at normal pressure, applying one or more photoinitiators containing at least one ethylenically unsaturated group to the inorganic or organic substrate, and allowing reaction with the free-radical sites formed there; and
c1) coating the substrate so precoated with photoinitiator with a composition comprising at least one ethylenically unsaturated monomer or oligomer, and curing the coating by means of UV/VIS radiation, or
c2) depositing a metal, semi-metal oxide or metal oxide from the gaseous phase, in the presence of UV light, on the substrate so precoated with photoinitiator.

WO03064061 relates to a process for the production of a strongly adherent coating on an inorganic or organic substrate, wherein a) a low-temperature plasma treatment, a corona discharge treatment or a flame treatment is carried out on the inorganic or organic substrate, b) one or more photoinitiators or mixtures of photoinitiators with monomers or/and oligomers, containing at least one ethylenically unsaturated group, or solutions, suspensions or emulsions of the afore-mentioned substances, are applied at normal pressure to the inorganic or organic substrate, and c) using suitable methods those afore-mentioned substances are optionally dried and/or are irradiated with electromagnetic waves.

WO06/067061 relates to a process for the production of strongly adherent coatings on an inorganic or organic substrate, wherein in a first step a) a low-temperature plasma, a corona discharge or a flame is caused to act on the inorganic or organic substrate, in a second step b) one or more defined photoinitiators or mixtures of defined photoinitiators with monomers, containing at least one ethylenically unsaturated group, or solutions, suspensions or emulsions of the afore-mentioned substances, are applied, preferably at normal pressure, to the inorganic or organic substrate, in a third step c) using suitable methods those afore-mentioned substances are dried and/or irradiated with electromagnetic waves and, optionally, in a fourth step d) on the substrate so pretreated is applied a further coating.

WO2013178523 (U.S. Pat. No. 9,718,974) relates to low-viscosity formulations of radiation-curable compounds, methods for the production thereof, the use thereof, and inks, printing inks, and printing varnishes containing said compound formulations.

It has now been found, surprisingly, that by coating a flexible substrate first with a primer layer and then with an embossed film the adherence of the embossed film to the substrate is improved while simultaneously keeping the optical performance of the embossed film in an acceptable range.

Accordingly, the present application relates to a process for the production of strongly adherent films on flexible substrates comprising

a) optionally exposing the flexible substrate to a corona discharge or a plasma discharge treatment;
b) applying a primer composition on the substrate, which comprises
b1) at least one polyurethane (A) comprising as synthesis components
(b1a) at least one organic aliphatic, aromatic or cycloaliphatic diisocyanate or polyisocyanate having a functionality of more than 2,
(b1b) at least one compound having in each case at least one isocyanate-reactive group and at least one radically polymerizable unsaturated group,
(b1c) at least one photoinitiator having at least one isocyanate-reactive group,
b2) at least one polyfunctional polymerizable compound (B),
b3) a solvent, or a mixture of solvents,
c) evaporating the solvent by applying IR-radiation and/or thermal drying,
d) curing the primer layer by means of UV/VIS radiation or electron beam,
e) optionally exposing the primered substrate to a corona discharge or a plasma discharge treatment,
f) applying a curable composition onto the primer coating,
g) optionally contacting at least a portion of the curable composition with surface relief micro-structure forming means,
h) curing the optionally embossed film by means of UV/VIS radiation or electron beam, and
i) optionally depositing a layer of a transparent high refractive index material and/or a metallic layer on at least a portion of the cured composition.

In a preferred embodiment the process of the present invention is directed to the production of strongly adherent embossed films on flexible substrates and comprises

a) optionally exposing the flexible substrate to a corona discharge or a plasma discharge treatment;
b) applying a primer composition on the substrate, which comprises
b1) at least one polyurethane (A) comprising as synthesis components
(b1a) at least one organic aliphatic, aromatic or cycloaliphatic diisocyanate or polyisocyanate having a functionality of more than 2,
(b1b) at least one compound having in each case at least one isocyanate-reactive group and at least one radically polymerizable unsaturated group,
(b1c) at least one photoinitiator having at least one isocyanate-reactive group,
b2) at least one polyfunctional polymerizable compound (B),
b3) a solvent, or a mixture of solvents,
c) evaporating the solvent by applying IR-radiation and/or thermal drying,
d) curing the primer layer by means of UV/VIS radiation or electron beam,
e) optionally exposing the primered substrate to a corona discharge or a plasma discharge treatment,
f) applying a curable composition onto the primer coating,
g) contacting at least a portion of the curable composition with surface relief micro-structure forming means,
h) curing the embossed film by means of UV/VIS radiation or electron beam, and
i) optionally depositing a layer of a transparent high refractive index material and/or a metallic layer on at least a portion of the cured composition.

In a more preferred embodiment the process of the present comprises

a) exposing the flexible substrate to a corona discharge or a plasma discharge treatment;
b) applying the primer composition on the substrate,
c) evaporating the solvent by applying IR-radiation and/or thermal drying,
d) curing the primer layer by means of UV/VIS radiation or electron beam,
f) applying a curable composition onto the primer coating,
g) contacting at least a portion of the curable composition with surface relief micro-structure forming means,
h) curing the embossed film by means of UV/VIS radiation, and
i) optionally depositing a layer of a transparent high refractive index material and/or a metallic layer on at least a portion of the cured composition.

The embossed films obtained by the process of the present invention have peelforces >20 N/m.

As materials for the flexible substrate, explicit mention should be made here of polyethylene terephthalate, polyethylene naphthalate, polyvinyl butyral, polyvinyl chloride, flexible polyvinyl chloride, polymethyl methacrylate, poly(ethylene-co-vinyl acetate), polycarbonate, cellulose triacetate, polyether sulfone, polyester, polyamide, polyolefins, such as, for example, polypropylene, and acrylic resins. Among these, polyethylene terephthalate, polyvinyl butyral, polyvinyl chloride, flexible polyvinyl chloride and polymethyl methacrylate are preferred.

The flexible substrate is preferably biaxially oriented.

The flexible substrate is preferably selected from a biaxially oriented polyethylene terephthalate (BOPET) film, or a biaxially oriented polypropylene (BOPP) film.

Process steps a) and e) are optional. In a preferred embodiment of the present invention the process comprises step a), while step e) is omitted. In another preferred embodiment of the present invention the process does not comprise step a) and e).

The principles of plasma production and maintenance are described, for example, in H. J. Jacobasch et al. in Farbe+Lack 99(7), 602-607 (1993) for low-temperature plasmas under vacuum conditions and by J. Friedrich et al. in Surf. Coat. Technol. 59, 371-6(1993) for plasmas ranging from in vacuo up to normal pressure conditions, the low-temperature plasma changing into a corona discharge.

Process steps a) and e) process can also be carried out under corona discharge conditions. Corona discharges are produced under normal pressure conditions, the ionised gas used being most frequently air. In principle, however, other gases and mixtures are also possible, as described, for example, in COATING Vol. 2001, No. 12, 426, (2001).

When a corona discharge is used, air, CO₂ and/or nitrogen are preferably used as the gas. It is especially preferred to use air, H₂, CO₂, He, Ar, Kr, Xe, N₂, O₂ or H₂O singly or in the form of a mixture.

The plasma treatment of the flexible substrate preferably takes place for from 1 ms to 300 s, especially from 10 ms to 200 s.

After the plasma-, or corona-treatment the primer composition is applied on the flexible substrate in process step b). In principle, it is advantageous to apply the primer composition as quickly as possible after the plasma- or corona-treatment.

The primer composition can be applied in process step b) by means of customary processes, for example by means of processes selected from slot die-, knive-, reverse roll-, metering rod coating, gravure-, flexo-, screen-, or ink jet printing.

In process step c) the evaporating of the solvent is done by applying infrared radiation (IR radiation), and/or thermal drying, for example, by means of hot air, a hot plate.

The evaporating of the solvent is affected preferably at elevated temperature, i.e. by heating, optionally under reduced pressure. It is preferred to carry out process step (c) at a temperature of from 40 to 140° C., more preferably from 60 to 120° C. The thermal energy can originate both from an external heat source as well as from the UV light source, for example a UV lamp. Preferably the thermal energy originates at least partly from a heat source different from the UV light source, for example from an oven or a heating plate.

Radiation curing in process steps d) and h) takes place with high-energy light, such as, for example, UV/VIS radiation, or electron beams. Radiation curing may also take place at relatively high temperatures.

Examples of suitable radiation sources for the radiation cure are low-pressure mercury lamps, medium-pressure mercury lamps with high-pressure lamps, and fluorescent tubes, pulsed lamps, metal halide lamps, or excimer lamps and also UV LEDs. The radiation cure is accomplished by exposure to high-energy radiation, i.e., UV/VIS radiation, preferably light in the wavelength range of λ=200 to 700 nm, more preferably λ=200 to 500 nm, or by exposure to high-energy electrons (electron beams; 60 to 300 keV). Examples of radiation sources used include high-pressure mercury vapor lamps, lasers, pulsed lamps (flash light), halogen lamps, UV LEDs, or excimer lamps. The radiation dose normally sufficient for crosslinking in the case of UV curing is in the range from 30 to 3000 mJ/cm².

The curable composition is applied to the substrate.

The curable composition can be applied in process step f) by means of customary processes, for example by means of processes selected from airblade coating, knife coating, airknife coating, squeegee coating, impregnation coating, reverse roll coating, transfer roll coating, gravure coating, kiss coating, flow coating, spray coating, spin coating, or printing processes such as relief printing, gravure printing, intaglio printing, flexographic printing, offset printing, inkjet printing, letterpress printing, pad printing, heatseal printing or screenprinting processes.

The curable composition is preferably applied by slot die-, knive-, reverse roll-, metering rod coating, gravure-, flexo-, screen-, or ink jet printing.

In process step g) at least a portion of the curable composition is contacted with surface relief micro-structure forming means. The surface relief micro-structure is especially an optically variable image (OVI, or an optically variable device (OVD)).

The surface relief microstructure forming means is preferably a shim, which is selected from the group consisting of a nickel sleeve; a nickel plate; an etched, or laser imaged metallic drum, or other materials mounted on an opaque cylinder or metal cylinder containing the surface relief microstructure (OVI) on the surface. The surface relief microstructure forming means may comprise means for cooling.

The primer composition used in process step b) is new, forms a further subject of the present application and comprises

b1) at least one polyurethane (A) comprising as synthesis components
(b1a) at least one organic aliphatic, aromatic or cycloaliphatic diisocyanate or polyisocyanate having a functionality of more than 2,
(b1b) at least one compound having in each case at least one isocyanate-reactive group and at least one radically polymerizable unsaturated group,
(b1c) at least one photoinitiator having at least one isocyanate-reactive group,
b2) at least one polyfunctional polymerizable compound (B),
b3) a solvent, or a mixture of solvents,

The polyurethane (A) and its production is described in WO2013178523. synthesizing a polyurethane (A) comprising as synthesis components

(b1a) at least one polyisocyanate containing allophanate groups and having an NCO functionality of at least 2, synthesized from aliphatic C4 to C20 alkylene diisocyanates,
(b1b) at least one compound having in each case at least one isocyanate-reactive group and at least one radically polymerizable unsaturated group,
(b1c) at least one photoinitiator having at least one isocyanate-reactive group, under anhydrous conditions, wherein the polyurethanes (A) are prepared in the presence of less than 1000 ppm by weight of a bismuth, zinc- and/or titanium-containing compound.

Component (b1a) comprises polyisocyanates which contain allophanate groups and have an NCO functionality of at least 2, preferably of 2 to 5, and more preferably of 2 to 4. The polyisocyanates (a) containing allophanate groups are synthesized from aliphatic C4 to C₂₀ alkylene diisocyanates, preferably from hexamethylene 1,6-diisocyanate.

In one particularly preferred embodiment the compound in question is a polyisocyanate which contains allophanate groups and has the formula

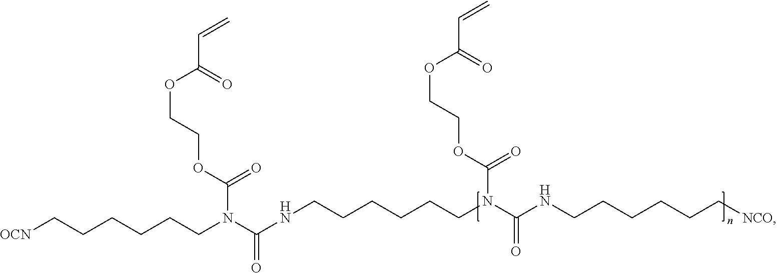

in which
n is a positive number which is on average 1 up to 5, preferably from 1 to 3.

The compounds (b1b) preferably have precisely one isocyanate-reactive group and 1 to 5, more preferably 1 to 4, and very preferably 1 to 3 radically polymerizable groups.

The components (b1b) preferably have a molar weight of below 10 000 g/mol, more preferably below 5000 g/mol, very preferably below 4000 g/mol, and more particularly below 3000 g/mol. Special components (b) have a molar weight of below 1000 or even below 600 g/mol.

Preference is given to using 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol mono(meth)acrylate and di(meth)acrylate, trimethylolpropane mono(meth)acrylate and di(meth)acrylate, pentaerythritol mono(meth)acrylate, di(meth)acrlate, and tri(meth)acrylate, and also 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypro-pyl(meth)acrylamide, or 3-hydroxypropyl(meth)acrylamide. Particularly preferred are 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl (meth)acrylate, and also the monoacrylates of polyethylene glycol with a molar mass of 106 to 238. In one preferred embodiment, component (b) may also comprise technical mixtures from the acrylation of trimethylolpropane, pentaerythritol, ditrimethylolpropane or dipentaerythritol, or alkoxylated, preferably propoxylated and/or ethoxylated, more preferably ethoxylated, trimethylolpropane, pentaerythritol, ditrimethylolpropane or dipentaerythritol.

Component (b1c) is at least one photoinitiator having at least one isocyanate-reactive group, preferably at least one photoinitiator of the α-hydroxyacetophenone type or benzophenone type, in each case having at least one isocyanate-reactive group, and more preferably at least one photoinitiator of the α-hydroxyacetophenone type.

A photoinitiator for the purposes of this specification is a compound which can be cleaved into at least one radical by electromagnetic radiation, preferably by UV radiation, visible light or IR radiation, more preferably by UV radiation or visible light, and very preferably by UV radiation.

Component (b1c) may comprise one or more than one—for example, 1 to 3, preferably 1 to 2, and more preferably precisely one—group which is active as a photoinitiator, preferably α-hydroxyacetophenone group or benzophenone group, more preferably α-hydroxyacetophenone group. Moreover, component (c) may comprise one or more than one—for example, 1 to 4, preferably 1 to 3, more preferably 1 to 2 and very preferably precisely one—isocyanate-reactive group.

The groups which are active as photoinitiators may preferably be hydroxybenzophenones or hydroxyacetophenones, and more preferably hydroxyacetophenones.

Preferred components (b1c) are

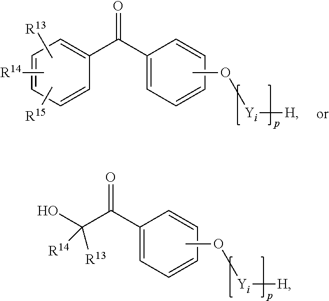

in which
R¹³, R¹⁴, and R¹⁵ each independently of one another are hydrogen, an alkyl group containing 1 to 4 carbon atoms or an alkyloxy group containing 1 to 4 carbon atoms,
p may be 0 (zero) or an integer from 1 to 10, and
Yᵢ for i=1 to p independently of one another may be selected from the group of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group of —CH₂—CH₂—O—, —CH₂—CH(CH₃)—O—, and —CH(CH₃)—CH₂—O—, and more preferably —CH₂—CH₂—O—, in which Ph is phenyl and Vin is vinyl.

The group —O—[—Yᵢ-]ₚ-H is preferably located in para-position to the carbonyl group.

The radicals R¹³, R¹⁴, and R¹⁵ independently of one another are preferably hydrogen or methyl, more preferably hydrogen.

Preferably p is 0 to 4, more preferably it is 1 to 3, and very preferably it is 1.

Preferred components (b1c) are 2-hydroxy-2-methyl-1-phenyl-propan-1-one, 1-hydroxycyclohexyl phenyl ketone, 1-[4-(2-hydroxyethoxy)phenyl]-2-hydroxy-2-methyl-1-propan-1-one, 2-hydroxy-1-{4-[4-(2-hydroxy-2-methylpropionyl)benzyl]phenyl}-2-methylpropan-1-one, 2-hydroxy-1-[4-[hydroxy[4-(2-hydroxy-2-methyl-propanoyl)phenyl]methyl]phenyl]-2-methyl-propan-1-one, [4-[3-(4-benzoylphenoxy)-2-hydroxypropoxy]phenyl]phenylmethanone, benzoin, benzoin isobutyl ether, benzoin tetrahydropyranyl ether, benzoin methyl ether, benzoin ethyl ether, benzoin butyl ether, benzoin isopropyl ether, 7H-benzoin methyl ether, 2-hydroxy-2,2-dimethylacetophenone, or 1-hydroxyacetophenone.

Particularly preferred are 1-[4-(2-hydroxyethoxy)phenyl]-2-hydroxy-2-methyl-1-propan-1-one, 2-hydroxy-1-{4-[4-(2-hydroxy-2-methylpropionyl)benzyl]phenyl}-2-methyl-propan-1-one, and 2-hydroxy-1-[4-[hydroxy-[4-(2-hydroxy-2-methylpropanoyl)phenyl]methyl]phenyl]-2-methylpropan-1-one; especially preferred is 1-[4-(2-hydroxyethoxy)phenyl]-2-hydroxy-2-methyl-1-propan-1-one.

The polyurethane (A) is preferably a compound of formula

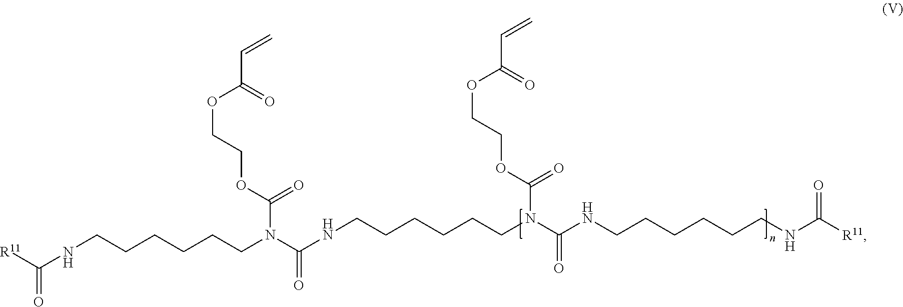

wherein n is a positive number which is on average 1 up to 5, preferably from 1 to 3, and R¹¹ is a group of formula

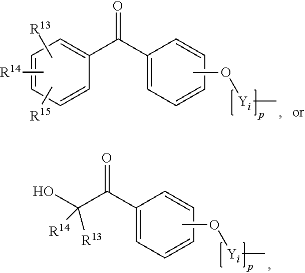

in which
R¹³, R¹⁴, and R¹⁵ each independently of one another are hydrogen, an alkyl group containing 1 to 4 carbon atoms or an alkyloxy group containing 1 to 4 carbon atoms, p may be 0 (zero) or an integer from 1 to 10, and
Yᵢ for i=1 to p independently of one another may be selected from the group of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group of —CH₂—CH₂—O—, —CH₂—CH(CH₃)—O—, and —CH(CH₃)—CH₂—O—, and more preferably —CH₂—CH₂—O—, in which Ph is phenyl and Vin is vinyl.

More preferred are compounds of formula (V), wherein n is 1, and R¹¹ is a group of formula

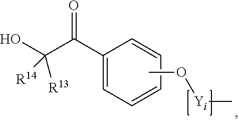

in which
R¹³ and R¹⁴ each independently of one another are an alkyl group containing 1 to 4 carbon atoms,
Yᵢ for is a group of —CH₂—CH₂—, —CH₂—CH(CH₃)—O—, and —CH(CH₃)—CH₂—O—, preferably —CH₂—CH₂—O—.

The polyfunctional polymerizable compounds (B) may contain two or more ethylenically unsaturated double bonds. They may be lower molecular weight (monomeric) or higher molecular weight (oligomeric).

Examples of polyfunctional polymerizable compounds (B) are ethylene glycol diacrylate, 1,6-hexanediol diacrylate, propylene glycol diacrylate, dipropylene glycol diacrylate, tripropylene glycol diacrylate, ditrimethylol tetracrylate, neopentyl glycol diacrylate, hexamethylene glycol diacrylate and bisphenol-A diacrylate, 4,4′-bis(2-acryloyloxyethoxy)diphenylpropane, trimethylolpropane triacrylate, pentaerythritol triacrylate, pentaerythritol tetraacrylate, vinyl acrylate, divinylbenzene, divinyl succinate, diallyl phthalate, triallyl phosphate, triallyl isocyanurate, tris(hydroxyethyl) isocyanurate triacrylate (Sartomer® 368; from Arkema) and tris(2-acryloylethyl) isocyanurate, ethyleneglycoldivinylether, diethyleneglycoldivinylether, triethylene glycoldivinylether, polyethyleneglycol-mono-(meth)acrylate, polyethyleneglycol-di-(meth)acrylate, and vinyl(meth)acrylat.

It is also possible to use polyester polyol acrylates, polyetherol acrylates and acrylic esters of alkoxylated polyols, for example triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol.

Examples of higher molecular weight (oligomeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition, it is also possible to use vinyl ether monomers and oligomers, and also maleate-terminated oligomers having polyester, polyurethane, polyether, polyvinyl ether and epoxide main chains. In particular, combinations of vinyl-ether-group-carrying oligomers and polymers, as described in WO 90/01512, are suitable.

Also suitable are, for example, esters of ethylenically unsaturated carboxylic acids and polyols.

Examples of unsaturated carboxylic acids are acrylic acid, methacrylic acid, crotonic acid, maleic acid, fumaric acid, itaconic acid, cinnamic acid and unsaturated fatty acids such as linolenic acid or oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)propane, and novolaks and resols.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols from 200-35000, preferably from 200 to 1500, polypropylene glycols having molecular weights from 200-35000, preferably from 200 to 1500, polytetrahydrofuranes having molecular weights from 200-50000, preferably from 200 to 2000, 1,3-cyclopentanediol, 1,2-, 1,3- or 1,4-cyclohexanediol, 1,4-dihydroxymethylcyclo-hexane, glycerol, tris(ß-hydroxyethyl)amine, trimethylolethane, trimethylolpropane, pentaerythritol, dipentaerythritol and sorbitol.

The polyols may have been partially or fully esterified by one or by different unsaturated carboxylic acid(s), it being possible for the free hydroxyl groups in partial esters to have been modified, for example etherified, or esterified by other carboxylic acids.

Examples of esters are:

trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and triacrylate, 1,4-cyclohexane diacrylate, bisacrylates and bismethacrylates of polyethylene glycol having a molecular weight of from 200 to 1500, and mixtures thereof.

Also suitable are the amides of identical or different unsaturated carboxylic acids and 30 aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diamino-cyclohexane, isophoronediamine, phenylenediamine, bisphenylenediamine, di-ß-aminoethyl ether, diethylenetriamine, triethylenetetramine and di(ß-aminoethoxy)- and di(ß-aminopropoxy)-ethane. Examples of such unsaturated amides are: methylene bisacrylamide, 1,6-hexamethylene bisacrylamide, diethylenetriamine trismethacrylamide, bis(methacrylamidopropoxy)ethane, ß-methacryl-amidoethyl methacrylate and N-[(ß-hydroxyethoxy)ethyl]-acrylamide.

In the context of the present application the term (meth)acrylate includes both the acrylate and the methacrylate.

The polymerizable compound (B) is preferably selected from 1,2-propanediol diacrylate, 1,3-propanediol diacrylate, dipropylene glycol diacrylate, polyethylene glycol diacrylate, polyethylene glycol dimethacrylate, tripropylene glycol diacrylate, trimethylolpropane triacrylate, ditrimethylol tetracrylate, dipentaerythritol hexaacrylate, triacrylate of singly to vigintuply alkoxylated, more preferably singly to vigintuply ethoThe xylated trimethylolpropane, singly to vigintuply propoxylated glycerol or singly to vigintuply ethoxylated and/or propoxylated pentaerythritol.

Polyethylene glycol diacrylates and dimethacrylates having a molecular weight of from 200 to 1500, such as, for example, SARTOMER® 259 (polyethylene glycol (200) diacrylate), 344 (polyethylene glycol (400) diacrylate), 610 (polyethylene glycol (600) diacrylate), 603 (polyethylene glycol (400) dimethacrylate), 252 (polyethylene glycol (600) dimethacrylate) (commercially available by Arkema) are most preferred.

The weight ratio of polyurethane (A) to polymerisable compound (B) is within the range of 3:1 to 1:3, especially.

Solvents b3) include, for example, C₁-C₆-alcohols, for example methanol, ethanol, n-propanol, isopropanol, butanol, isobutanol, sec-butanol, tert-butanol, n-pentanol, n-hexanol, and isomers thereof, glycols, for example 1,2-ethylene glycol, 1,2- or 1,3-propylene glycol, 1,2-, 2,3- or 1,4-butylene glycol, di- or triethylene glycol or di- or tripropylene glycol, ethers, for example open-chain ethers such as methyl tert-butyl ether, 1,2-ethylene glycol monomethyl or dimethyl ether, 1,2-ethylene glycol monoethyl or diethyl ether, 3-methoxypropanol or 3-isopropoxypropanol, or cyclic ethers such as tetrahydrofuran or dioxane, open-chain ketones, for example acetone, methyl ethyl ketone, methyl isobutyl ketone or diacetone alcohol (4-hydroxy-4-methyl-2-pentanone), cyclic ketones such as cyclopentanone or cyclohexanone, C₁-C₅-alkyl esters, for example methyl acetate, ethyl acetate, propyl acetate, butyl acetate or amyl acetate, C₁-C₄-alkoxy-C₁-C₄-alkyl esters such as 1-methoxyprop-2-yl acetate, carboxamides such as dimethylformamide and dimethylacetamide, N-heterocycles such as N-methylpyrrolidone, aliphatic or aromatic hydrocarbons, for example pentane, hexane, heptane, octane, isooctane, petroleum ether, toluene, xylene, ethylbenzene, tetralin, decalin, dimethylnaphthalene, white spirit, Shellsol® or Solvesso®. As a matter of course, mixtures of these solvents are also useful for use in the inventive mixtures.

The solvent (b3)) is preferably selected from C₁-C₆alcohols, ether-C₁-C₆alcohols, such as, for example, 3-methoxypropanol, or 3-isopropoxypropanol, and mixtures thereof.

The proportion of the solvent is 90.0 to 99.5% by weight, especially 95.0 to 99.5% by weight, very especially 98.0 to 99.5% by weight, the proportion of compound (B) and the polyurethane (A) is 10 to 0.5% by weight, especially 5.0 to 0.5% by weight, very especially 2.0 to 0.5% by weight wherein the proportions of solvent, compound (B) and polyurethane (A) add up to 100% by weight.

In step f) a curable composition is applied onto the primer coating. The curable composition is preferably an UV curable composition. UV curing can be replaced by EB curing, thus eliminating the need for a photoinitiator. The composition is preferably deposited by means of gravure, flexographic, ink jet, offset and screen printing process.

The UV curable composition comprises photoinitiator(s) and unsaturated compound(s) including one or more olefinic double bonds (binder).

Examples of photoinitiators are known to the person skilled in the art and for example published by Kurt Dietliker in “A compilation of photoinitiators commercially available for UV today”, Sita Technology Textbook, Edinburgh, London, 2002.

Examples of suitable acylphosphine oxide compounds are of the formula XII

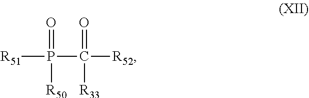

wherein
R₅₀ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR₅₃R₅₄;
or R₅₀ is unsubstituted C₁-C₂₀alkyl or is C₁-C₂₀alkyl which is substituted by one or more halogen, C₁-C₁₂alkoxy, C₁-C₁₂alkylthio, NR₅₃R₅₄ or by —(CO)—O—C₁-C₂₄alkyl;
R₅₁ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR₅₃R₅₄; or R₅₁ is —(CO)R₅₂; or R₅₁ is C₁-C₁₂alkyl which is unsubstituted or substituted by one or more halogen, C₁-C₁₂alkoxy, C₁-C₁₂alkylthio, or by NR₅₃R₅₄;
R₅₂ and R′₅₂ independently of each other are unsubstituted cyclohexyl, cyclopentyl, phenyl, naphthyl or biphenylyl, or are cyclohexyl, cyclopentyl, phenyl, naphthyl or biphenylyl substituted by one or more halogen, C₁-C₄alkyl or C₁-C₄alkoxy; or R₅₂ is a 5- or 6-membered heterocyclic ring comprising an S atom or N atom;
R₅₃ and R₅₄ independently of one another are hydrogen, unsubstituted C₁-C₁₂alkyl or C₁-C₁₂alkyl substituted by one or more OH or SH wherein the alkyl chain optionally is interrupted by one to four oxygen atoms; or R₅₃ and R₅₄ independently of one another are C₂-C₁₂-alkenyl, cyclopentyl, cyclohexyl, benzyl or phenyl;

Specific examples are bis(2,4,6-trimethylbenzoyl)-phenylphosphine oxide (Irgacure®819); 2,4,6-trimethylbenzoyl-diphenyl-phosphine oxide (Darocur®TPO); ethyl (2,4,6 trimethylbenzoyl phenyl) phosphinic acid ester; (2,4,6-trimethylbenzoyl)-2,4-dipentoxyphenylphosphine oxide, bis(2,6-dimethoxybenzoyl)-2,4,4-trimethylpentylphosphineoxide.

Interesting further are mixtures of the compounds of the formula XII with compounds of the formula XI as well as mixtures of different compounds of the formula XII.

Examples are mixtures of bis(2,6-dimethoxybenzoyl)-2,4,4-trimethylpentylphosphine oxide with 1-hydroxy-cyclohexyl-phenyl-ketone, of bis(2,4,6-trimethylbenzoyl)-phenylphosphine oxide with 2-hydroxy-2-methyl-1-phenyl-propan-1-one, of bis(2,4,6-trimethylbenzoyl)-phenylphosphine oxide with ethyl (2,4,6 trimethylbenzoyl phenyl) phosphinic acid ester, etc.

Examples of suitable benzophenone compounds are compounds of the formula X:

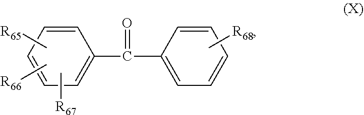

wherein
R₆₅, R₆₆ and R₆₇ independently of one another are hydrogen, C₁-C₄alkyl, C₁-C₄-halogenalkyl, C₁-C₄alkoxy, Cl or N(C₁-C₄alkyl)₂;
R₆₈ is hydrogen, C₁-C₄alkyl, C₁-C₄halogenalkyl, phenyl, N(C₁-C₄alkyl)₂, COOCH₃,

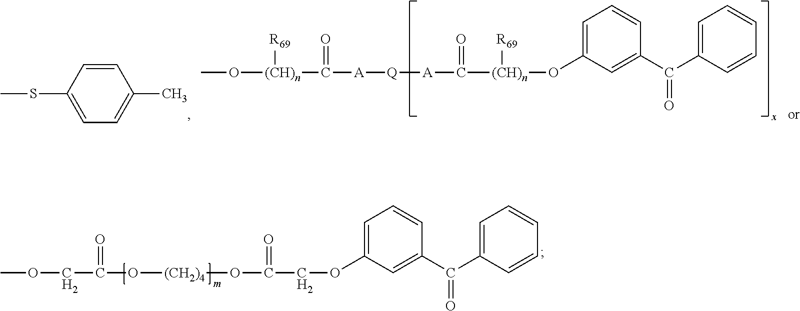

Q is a residue of a polyhydroxy compound having 2 to 6 hydroxy groups;
x is a number greater than 1 but no greater than the number of available hydroxyl groups in Q;
A is —[O(CH₂)_{b}CO]_{y}— or —[O(CH₂)_{b}CO]_{(y-1)}—[O(CHR₆₉CHR_{69′})ₐ]_{y}—;
R₆₉ and R_{69′} independently of one another are hydrogen, methyl or ethyl; and if N is greater than 1 the radicals R₆₉ may be the same as or different from each other;
a is a number from 1 to 2;
b is a number from 4 to 5;
y is a number from 1 to 10;
n is; and
m is an integer 2-10.

Specific examples are Darocur®BP (=benzophenone), Esacure TZT® available from IGM, (a mixture of 2,4,6-trimethylbenzophenone and 4-methylbenzophenone), 4-phenylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenyl)benzophenone, 3,3′-dimethyl-4-methoxybenzophenone, methyl-2-benzoylbenzoate, 4-(2-hydroxyethylthio)benzophenone, 4-(4-tolylthio)benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)benzophenone, 4-benzoyl-N,N-dimethyl-N-[2-(1-oxo-2-propenyl)oxy]ethylbenzenemethanaminium chloride; [4-(2-hydroxy-ethylsulfanyl)-phenyl]-(4-isopropylphenyl)-methanone; biphenyl-[4-(2-hydroxy-ethylsulfanyl)-phenyl]-methanone; biphenyl-4-yl-phenyl-methanone; biphenyl-4-yl-p-tolyl-methanone; biphenyl-4-yl-m-tolyl-methanone; [4-(2-hydroxy-ethylsulfanyl)-phenyl]-p-tolyl-methanone; [4-(2-hydroxy-ethylsulfanyl)-phenyl]-(4-isopropyl-phenyl)-methanone; [4-(2-hydroxy-ethylsulfanyl)-phenyl]-(4-methoxy-phenyl)-methanone; 1-(4-benzoyl-phenoxy)-propan-2-one; [4-(2-hydroxy-ethylsulfanyl)-phenyl]-(4-phenoxy-phenyl)-methanone; 3-(4-benzoyl-phenyl)-2-dimethylamino-2-methyl-1-phenyl-propan-1-one; (4-chloro-phenyl)-(4-octylsulfanyl-phenyl)-methanone; (4-chloro-phenyl)-(4-dodecylsulfanyl-phenyl)-methanone; (4-bromo-phenyl)-(4-octylsulfanyl-phenyl)-methanone; (4-dodecylsulfanyl-phenyl)-(4-methoxy-phenyl)-methanone; (4-benzoyl-phenoxy)-acetic acid methyl ester; biphenyl-[4-(2-hydroxy-ethylsulfanyl)-phenyl]-methanone; 1-[4-(4-benzoylphenylsulfanyl)phenyl]-2-methyl-2-(4-methylphenylsulfonyl)propan-1-one (Esacure®1001 available from IGM).

Examples of suitable alpha-hydroxy ketone, alpha-alkoxyketone or alpha-aminoketone compounds are of the formula (XI)

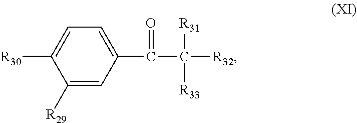

wherein
R₂₉ is hydrogen or C₁-C₁₈alkoxy;
R³⁰ is hydrogen, C₁-C₁₈alkyl, C₁-C₁₂hydroxyalkyl, C₁-C₁₈alkoxy, OCH₂CH₂—OR₃₄, morpholino, S—C₁-C₁₈alkyl, a group —HC═CH₂, —C(CH₃)═CH₂,

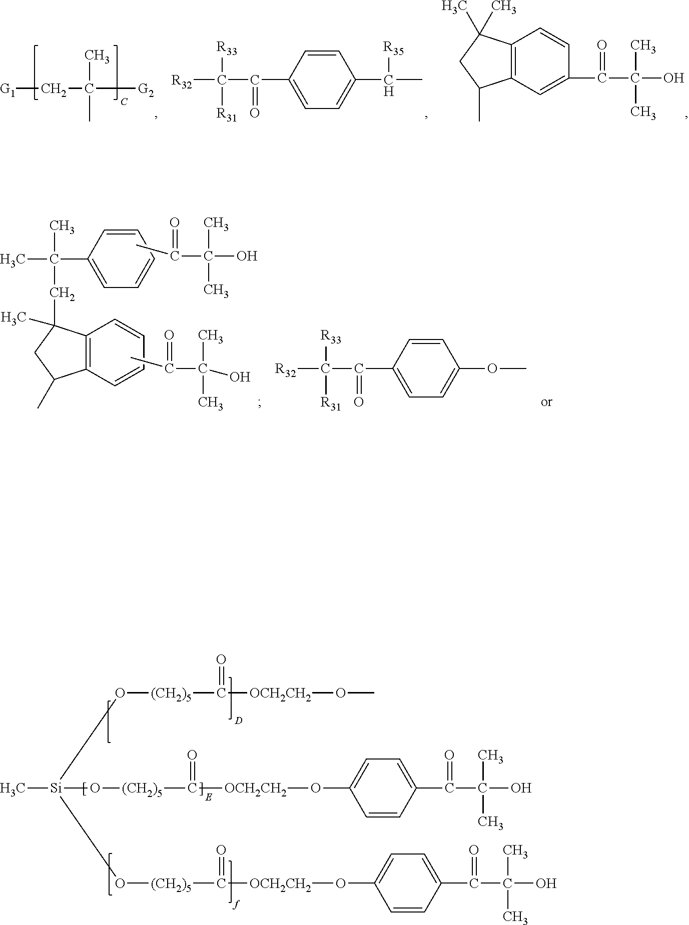

d, e and f are 1-3;
c is 2-10;
G₁ and G₂ independently of one another are end groups of the polymeric structure, preferably hydrogen or methyl;
R₃₄ is hydrogen,

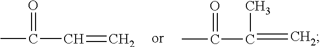

R₃₁ is hydroxy, C₁-C₁₆alkoxy, morpholino, dimethylamino or —O(CH₂CH₂O)_{g}—C₁-C₁₆alkyl;
g is 1-20;
R₃₂ and R₃₃ independently of one another are hydrogen, C₁-C₆alkyl, C₁-C₁₆alkoxy or —O(CH₂CH₂O)_{g}—C₁-C₁₆alkyl; or are unsubstituted phenyl or benzyl; or phenyl or benzyl substituted by C₁-C₁₂-alkyl; or R₃₂ and R₃₃ together with the carbon atom to which they are attached form a cyclohexyl ring;
R₃₅ is hydrogen, OR₃₆ or NR₃₇R₃₈;
R₃₆ is hydrogen, C₁-C₁₂alkyl which optionally is interrupted by one or more non-consecutive O— atoms and which uninterrupted or interrupted C₁-C₁₂alkyl optionally is substituted by one or more OH,

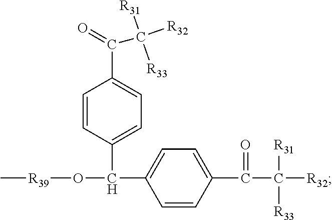

### or R₃₆ is

R₃₇ and R₃₈ independently of each other are hydrogen or C₁-C₁₂alkyl which is unsubstituted or is substituted by one or more OH;
R₃₉ is C₁-C₁₂alkylene which optionally is interrupted by one or more non-consecutive O, —(CO)—NH—C₁-C₁₂alkylene-NH—(CO)— or

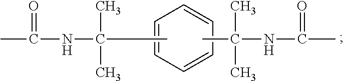

with the proviso that R₃₁, R₃₂ and R₃₃ not all together are C₁-C₁₆alkoxy or —O(CH₂CH₂O)_{g}—C₁-C₁₆alkyl.

Specific examples are 1-hydroxy-cyclohexyl-phenyl-ketone (Irgacure©184) or Irgacur© 500 (a mixture of Irgacure©184 with benzophenone), 2-methyl-1[4-(methylthio)phenyl]-2-morpholinopropan-1-one(Irgacure©907), 2-benzyl-2-dimethylamino-1-(4-morpholinophenyl)-butan-1-one(Irgacure©369), 2-dimethylamino-2-(4-methyl-benzyl)-1-(4-morpholin-4-yl-phenyl)-butan-1-one(Irgacure©379), (3,4-dimethoxy-benzoyl)-1-benzyl-1-dimethylamino propane, 1-[4-(2-hydroxyethoxy)-phenyl]-2-hydroxy-2-methyl-1-propan-1-one(Irgacure©2959), 2,2-dimethoxy-1,2-diphenylethan-1-one(Irgacure©651), 2-hydroxy-2-methyl-1-phenyl-propan-1-one(Darocur®1173), 2-hydroxy-1-{4-[4-(2-hydroxy-2-methyl-propionyl)-benzyl]-phenyl}-2-methyl-propan-1-one(Irgacure©127), 2-hydroxy-1-{4-[4-(2-hydroxy-2-methyl-propionyl)-phenoxy]-phenyl}-2-methyl-propan-1-one, Esacure KIP provided by IGM, 2-hydroxy-1-{1-[4-(2-hydroxy-2-methyl-propionyl)-phenyl]-1,3,3-trimethyl-indan-5-yl}-2-methyl-propan-1-one. Irgacure© and Darocur© products are available from BASF SE.

Examples of suitable phenylglyoxylate compounds are of the formula XIII

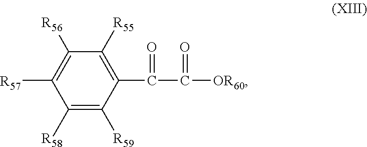

wherein
R₆₀ is hydrogen, C₁-C₁₂alkyl or

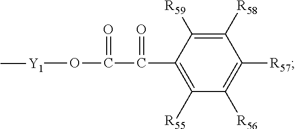

R₅₅, R₅₆, R₅₇, R₅₈ and R₅₉ independently of one another are hydrogen, unsubstituted C₁-C₁₂alkyl or C₁-C₁₂alkyl substituted by one or more OH, C₁-C₄alkoxy, phenyl, naphthyl, halogen or by CN; wherein the alkyl chain optionally is interrupted by one or more oxygen atoms; or R₅₅, R₅₆, R₅₇, R₅₈ and R₅₉ independently of one another are C₁-C₄alkoxy, C₁-C₄alkythio or NR₅₂R₅₃;
R₅₂ and R₅₃ independently of one another are hydrogen, unsubstituted C₁-C₁₂alkyl or C₁-C₁₂alkyl substituted by one or more OH or SH wherein the alkyl chain optionally is interrupted by one to four oxygen atoms; or R₅₂ and R₅₃ independently of one another are C₂-C₁₂-alkenyl, cyclopentyl, cyclohexyl, benzyl or phenyl; and
Y₁ is C₁-C₁₂alkylene optionally interrupted by one or more oxygen atoms.

Specific examples of the compounds of the formula XIII are oxo-phenyl-acetic acid 2-[2-(2-oxo-2-phenyl-acetoxy)-ethoxy]-ethyl ester (Irgacure®754), methyl α-oxo benzeneacetate. Examples of suitable oxime ester compounds are of the formula XIV

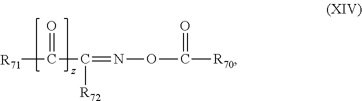

wherein z is 0 or 1;
R₇₀ is hydrogen, C₃-C₈cycloalkyl; C₁-C₁₂alkyl which is unsubstituted or substituted by one or more halogen, phenyl or by CN; or R₇₀ is C₂-C₅alkenyl; phenyl which is unsubstituted or substituted by one or more C₁-C₆alkyl, halogen, CN, OR₇₃, SR₇₄ or by NR₇₅R₇₆; or R₇₀ is C₁-C₈alkoxy, benzyloxy; or phenoxy which is unsubstituted or substituted by one or more C₁-C₆alkyl or by halogen;
R₇₁ is phenyl, naphthyl, benzoyl or naphthoyl, each of which is substituted by one or more halogen, C₁-C₁₂alkyl, C₃-C₈cycloalkyl, benzyl, phenoxycarbonyl, C₂-C₁₂alkoxycarbonyl, OR₇₃, SR₇₄, SOR₇₄, SO₂R₇₄ or by NR₇₅R₇₆, wherein the substituents OR₇₃, SR₇₄ and NR₇₅R₇₆ optionally form 5- or 6-membered rings via the radicals R₇₃, R₇₄, R₇₅ and/or Rye with further substituents on the phenyl or naphthyl ring; or each of which is substituted by phenyl or by phenyl which is substituted by one or more OR₇₃, SR₇₄ or by NR₇₅R₆₆;
or R₇₁ is thioxanthyl, or

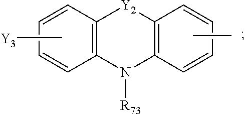

R₇₂ is hydrogen; unsubstituted C₁-C₂₀alkyl or C₁-C₂₀alkyl which is substituted by one or more halogen, OR₇₃, SR₇₄, C₃-C₈cycloalkyl or by phenyl; or is C₃-C₈cycloalkyl; or is phenyl which is unsubstituted or substituted by one or more C₁-C₆alkyl, phenyl, halogen, OR₇₃, SR₇₄ or by NR₇₅R₇₆; or is C₂-C₂₀alkanoyl or benzoyl which is unsubstituted or substituted by one or more C₁-C₆alkyl, phenyl, OR₇₃, SR₇₄ or by NR₇₅R₇₆; or is C₂-C₁₂alkoxycarbonyl, phenoxycarbonyl, CN, CONR₇₅R₇₆, NO₂, C₁-C₄haloalkyl, S(O)_{y}—C₁-C₆alkyl, or S(O)_{y}-phenyl,
y is 1 or 2;
Y₂ is a direct bond or no bond;
Y₃ is NO₂ or

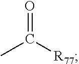

R₇₃ and R₇₄ independently of one another are hydrogen, C₁-C₂₀alkyl, C₂-C₁₂alkenyl, C₃-C₈cycloalkyl, C₃-C₈cycloalkyl which is interrupted by one or more, preferably 2, O, phenyl-C₁-C₃alkyl; or are C₁-C₈alkyl which is substituted by OH, SH, CN, C₁-C₈alkoxy, C₁-C₈alkanoyl, C₃-C₈cycloalkyl, by C₃-C₈cycloalkyl which is interrupted by one or more O, or which C₁-C₈alkyl is substituted by benzoyl which is unsubstituted or substituted by one or more C₁-C₆alkyl, halogen, OH, C₁-C₄alkoxy or by C₁-C₄alkylsulfanyl; or are phenyl or naphthyl, each of which is unsubstituted or substituted by halogen, C₁-C₁₂alkyl, C₁-C₁₂alkoxy, phenyl-C₁-C₃alkyloxy, phenoxy, C₁-C₁₂alkylsulfanyl, phenylsulfanyl, N(C₁-C₁₂alkyl)₂, diphenylamino or by

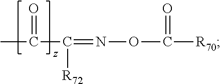

R₇₅ and R₇₆ independently of each other are hydrogen, C₁-C₂₀alkyl, C₂-C₄hydroxyalkyl, C₂-C₁₀alkoxyalkyl, C₂-C₅alkenyl, C₃-C₈cycloalkyl, phenyl-C₁-C₃alkyl, C₁-C₈alkanoyl, C₃-C₁₂alkenoyl, benzoyl; or are phenyl or naphthyl, each of which is unsubstituted or substituted by C₁-C₁₂alkyl, benzoyl or by C₁-C₁₂alkoxy; or R₇₅ and R₇₆ together are C₂-C₆alkylene optionally interrupted by O or NR₇₃ and optionally are substituted by hydroxyl, C₁-C₄alkoxy, C₂-C₄alkanoyloxy or by benzoyloxy;
R₇₇ is C₁-C₁₂alkyl, thienyl or phenyl which is unsubstituted or substituted by C₁-C₁₂alkyl, OR₇₃, morpholino or by N-carbazolyl.

Specific examples are 1,2-octanedione 1-[4-(phenylthio)phenyl]-2-(O-benzoyloxime) (Irgacure® OXE01), ethanone 1-[9-ethyl-6-(2-methylbenzoyl)-9H-carbazol-3-yl]-1-(0-acetyloxime) (Irgacure®OXE02), 9H-thioxanthene-2-carboxaldehyde 9-oxo-2-(O-acetyloxime), ethanone 1-[9-ethyl-6-(4morpholinobenzoyl)-9H-carbazol-3-yl]-1-(0-acetyloxime), ethanone 1-[9-ethyl-6-(2-methyl-4-(2-(1,3-dioxo-2-dimethyl-cyclopent-5-yl)ethoxy)-benzoyl)-9H-carbazol-3-yl]-1-(0-acetyloxime) (Adeka N-1919), ethanone 1-[9-ethyl-6-nitro-9H-carbazol-3-yl]-1-[2-methyl-4-(1-methyl-2-methoxy)ethoxy)phenyl]-1-(0-acetyloxime) (Adeka NC1831), etc.

It is also possible to add cationic photoinitiators, such as benzoyl peroxide (other suitable peroxides are described in U.S. Pat. No. 4,950,581, column 19, lines 17-25), or aromatic sulfonium, phosphonium or iodonium salts, such as are described, for example, in U.S. Pat. No. 4,950,581, column 18, line 60 to column 19, line 10.

Suitable sulfonium salt compounds are of formula XVa, XVb, XVc, XVd or XVe

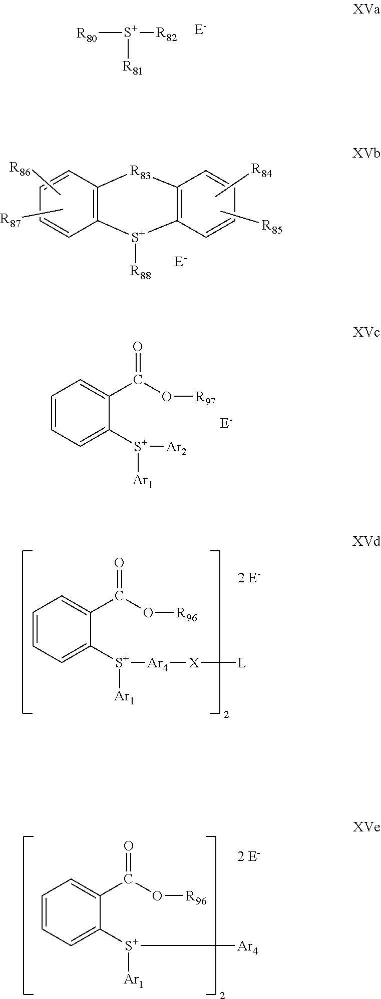

wherein
R₈₀, R₈₁ and R₈₂ are each independently of the others unsubstituted phenyl, or phenyl substituted by —S-phenyl,

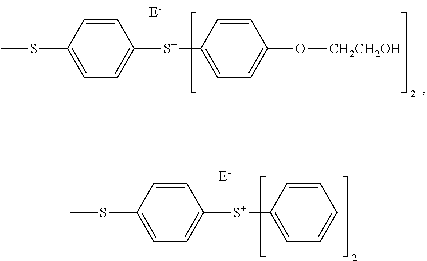

or by

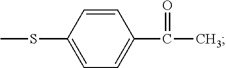

R₈₃ is a direct bond, S, O, CH₂, (CH₂)₂, CO or NR₈₉;
R₈₄, R₈₅, R₈₆ and R₈₇ independently of one another are hydrogen, C₁-C₂₀alkyl, C₃-C₈cycloalkyl, C₁-C₂₀alkoxy, C₂-C₂₀alkenyl, CN, OH, halogen, C₁-C₆alkylthio, phenyl, naphthyl, phenyl-C₁-C₇alkyl, naphtyl-C₁-C₃alkyl, phenoxy, naphthyloxy, phenyl-C₁-C₇alkyloxy, naphtyl-C₁-C₃alkyloxy, phenyl-C₂-C₆alkenyl, naphthyl-C₂-C₄alkenyl, S-phenyl, (CO)R₈₉, O(CO)R₈₉, (CO)OR₈₉, SO₂R₈₉ or OSO₂R₈₉;
R₈₈ is C₁-C₂₀alkyl, C₁-C₂₀hydroxyalkyl,

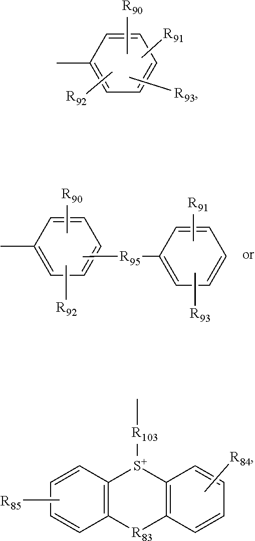

R₈₉ is hydrogen, C₁-C₁₂alkyl, C₁-C₁₂hydroxyalkyl, phenyl, naphthyl or biphenylyl;
R₉₀, R₉₁, R₉₂ and R₉₃ independently of one another have one of the meanings as given for R₄; or
R₉₀ and R₉₁ are joined to form a fused ring system with the benzene rings to which they are attached;
R₉₅ is a direct bond, S, O or CH₂;
R₉₆ is hydrogen, C₁-C₂₀alkyl; C₂-C₂₀alkyl interrupted by one or more O; or is -L-M-R₉₈ or -L-R₉₈;
R₉₇ has one of the meanings as given for R₉₆ or is

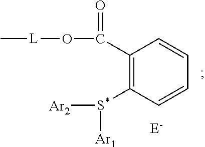

R₉₈ is a monovalent sensitizer or photoinitiator moiety;
Ar₁ and Ar₂ independently of one another are phenyl unsubstituted or substituted by C₁-C₂₀alkyl, halogen or OR₉₉;
or are unsubstituted naphthyl, anthryl, phenanthryl or biphenylyl;
or are naphthyl, anthryl, phenanthryl or biphenylyl substituted by C₁-C₂₀alkyl, OH or OR₉₉;
or are —Ar₄-A₁-Ar₃ or

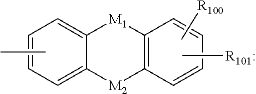

Ar₃ is unsubstituted phenyl, naphthyl, anthryl, phenanthryl or biphenylyl;
or is phenyl, naphthyl, anthryl, phenanthryl or biphenylyl substituted by C₁-C₂₀alkyl, OR₉₉ or benzoyl;
Ar₄ is phenylene, naphthylene, anthrylene or phenanthrylene;
A₁ is a direct bond, S, O or C₁-C₂₀alkylene;

### X is CO, C(O)O, OC(O), O, S or NR₉₉;

L is a direct bond, S, O, C₁-C₂₀alkylene or C₂-C₂₀alkylene interrupted by one or more non-consecutive O;
R₉₉ is C₁-C₂₀alkyl or C₁-C₂₀hydroxyalkyl; or is C₁-C₂₀alkyl substituted by O(CO)R₁₀₂;
M₁ is S, CO or NR₁₀₀;
M₂ is a direct bond, CH₂, O or S;
R₁₀₀ and R₁₀₁ independently of one another are hydrogen, halogen, C₁-C₈alkyl, C₁-C₈alkoxy or phenyl;
R₁₀₂ is C₁-C₂₀alkyl;

### R₁₀₃ is

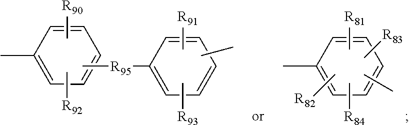

and
E is an anion, especially PF₆, SbF₆, AsF₆, BF₄, (C₆F₅)₄B, Cl, Br, HSO₄, CF₃—SO₃, F—SO₃,

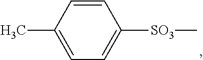

CH₃—SO₃, ClO₄, PO₄, NO₃, SO₄, CH₃—SO₄, or

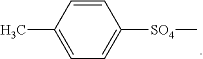

Specific examples of sulfonium salt compounds are for example Irgacure®270 (BASF SE); Cyracure® UVI-6990, Cyracure®UVI-6974 (Union Carbide), Degacure®KI 85 (Degussa), SP-55, SP-150, SP-170 (Asahi Denka), GE UVE 1014 (General Electric), SarCat®KI-85 (=triarylsulfonium hexafluorophosphate; Sartomer), SarCat® CD 1010 (=mixed triarylsulfonium hexafluoroantimonate; Sartomer); SarCat® CD 1011(=mixed triarylsulfonium hexafluorophosphate; Sartomer), Suitable iodonium salt compounds are of formula XVI

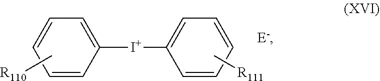

wherein
R₁₁₀ and R₁₁₁ are each independently of the other hydrogen, C₁-C₂₀alkyl, C₁-C₂₀alkoxy, OH-substituted C₁-C₂₀alkoxy, halogen, C₂-C₁₂alkenyl, C₃-C₈cycloalkyl, especially methyl, isopropyl or isobutyl; and
E is an anion, especially PF₆, SbF₆, AsF₆, BF₄, (C₆F₅)₄B, Cl, Br, HSO₄, CF₃—SO₃, F—SO₃,

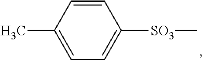

CH₃—SO₃, ClO₄, PO₄, NO₃, SO₄, CH₃—SO₄ or

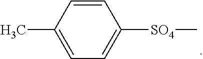

Specific examples of iodonium salt compounds are e.g. tolylcumyliodonium tetrakis(pentafluorophenyl)borate, 4-[(2-hydroxy-tetradecyloxy)phenyl]phenyliodonium hexafluoroantimonate or hexafluorophosphate, tolylcumyliodonium hexafluorophosphate, 4-isopropylphenyl-4′-methylphenyliodonium hexafluorophosphate, 4-isobutylphenyl-4′-methylphenyliodonium hexafluorophosphate (Irgacure©250, BASF SE), 4-octyloxyphenyl-phenyliodonium hexafluorophosphate or hexafluoroantimonate, bis(dodecylphenyl)iodonium hex-afluoroantimonate or hexafluorophosphate, bis(4-methylphenyl)iodonium hexafluorophosphate, bis(4-methoxyphenyl)iodonium hexafluorophosphate, 4-methylphenyl-4′-ethoxyphenyliodonium hexafluorophosphate, 4-methylphenyl-4′-dodecylphenyliodonium hexafluorophosphate, 4-methylphenyl-4′-phenoxyphenyliodonium hexafluorophosphate.

Of all the iodonium salts mentioned, compounds with other anions are, of course, also suitable. The preparation of iodonium salts is known to the person skilled in the art and described in the literature, for example U.S. Pat. Nos. 4,151,175, 3,862,333, 4,694,029, EP 562897, U.S. Pat. Nos. 4,399,071, 6,306,555, WO 98/46647 J. V. Crivello, “Photoinitiated Cationic Polymerization” in: UV Curing: Science and Technology, Editor S. P. Pappas, pages 24-77, Technology Marketing Corporation, Norwalk, Conn. 1980, ISBN No. 0-686-23773-0; J. V. Crivello, J. H. W. Lam, Macromolecules, 10, 1307 (1977) and J. V. Crivello, Ann. Rev. Mater. Sci. 1983, 13, pages 173-190 and J. V. Crivello, Journal of Polymer Science, Part A: Polymer Chemistry, Vol. 37, 4241-4254 (1999).

In certain cases it may be of advantage to use mixtures of two or more photoinitiators.

Halogen is fluorine, chlorine, bromine and iodine.

C₁-C₂₄alkyl (C₁-C₂₀alkyl, especially C₁-C₁₂alkyl) is typically linear or branched, where possible. Examples are methyl, ethyl, n-propyl, isopropyl, n-butyl, sec.-butyl, isobutyl, tert.-butyl, n-pentyl, 2-pentyl, 3-pentyl, 2,2-dimethylpropyl, 1,1,3,3-tetramethylpentyl, n-hexyl, 1-methylhexyl, 1,1,3,3,5,5-hexamethylhexyl, n-heptyl, isoheptyl, 1,1,3,3-tetramethylbutyl, 1-methylheptyl, 3-methylheptyl, n-octyl, 1,1,3,3-tetramethylbutyl and 2-ethylhexyl, n-nonyl, decyl, undecyl, dodecyl, tridecyl, tetradecyl, pentadecyl, hexadecyl, heptadecyl, or octadecyl. C₁-C₈alkyl is typically methyl, ethyl, n-propyl, isopropyl, n-butyl, sec.-butyl, isobutyl, tert.-butyl, n-pentyl, 2-pentyl, 3-pentyl, 2,2-dimethyl-propyl, n-hexyl, n-heptyl, n-octyl, 1,1,3,3-tetramethylbutyl and 2-ethylhexyl. C₁-C₄alkyl is typically methyl, ethyl, n-propyl, isopropyl, n-butyl, sec.-butyl, isobutyl, tert.-butyl.

C₂-C₁₂alkenyl (C₂-C₅alkenyl) groups are straight-chain or branched alkenyl groups, such as e.g. vinyl, allyl, methallyl, isopropenyl, 2-butenyl, 3-butenyl, isobutenyl, n-penta-2,4-dienyl, 3-methyl-but-2-enyl, n-oct-2-enyl, or n-dodec-2-enyl.

C₁-C₁₂alkoxy groups (C₁-C₈alkoxy groups) are straight-chain or branched alkoxy groups, e.g. methoxy, ethoxy, n-propoxy, isopropoxy, n-butoxy, sec-butoxy, tert-butoxy, amyloxy, isoamyloxy or tert-amyloxy, heptyloxy, octyloxy, isooctyloxy, nonyloxy, decyloxy, undecyloxy and dodecyloxy.

C₁-C₁₂alkylthio groups (C1-C alkylthio groups) are straight-chain or branched alkylthio groups and have the same preferences as the akoxy groups, except that oxygen is exchanged against sulfur.

C₁-C₁₂alkylene is bivalent C₁-C₁₂alkyl, i.e. alkyl having two (instead of one) free valencies, e.g. trimethylene or tetramethylene.

A cycloalkyl group is typically C₃-C₈cycloalkyl, such as, for example, cyclopentyl, cyclohexyl, cycloheptyl, or cyclooctyl, which may be unsubstituted or substituted.

In several cases it is advantageous to in addition to the photoinitiator employ a sensitizer compound. Examples of suitable sensitizer compounds are disclosed in WO 06/008251, page 36, line 30 to page 38, line 8, the disclosure of which is hereby incorporated by reference. As sensitizer inter alia benzophenone compounds as described above can be employed.

The unsaturated compounds may include one or more olefinic double bonds. They may be of low (monomeric) or high (oligomeric) molecular mass. Examples of monomers containing a double bond are alkyl, hydroxyalkyl or amino acrylates, or alkyl, hydroxyalkyl or amino methacrylates, for example methyl, ethyl, butyl, 2-ethylhexyl or 2-hydroxyethyl acrylate, isobornyl acrylate, methyl methacrylate or ethyl methacrylate. Silicone acrylates are also advantageous. Other examples are acrylonitrile, acrylamide, methacrylamide, N-substituted (meth)acrylamides, vinyl esters such as vinyl acetate, vinyl ethers such as isobutyl vinyl ether, styrene, alkyl- and halostyrenes, N-vinylpyrrolidone, vinyl chloride or vinylidene chloride.

Examples of monomers containing two or more double bonds are the diacrylates of ethylene glycol, propylene glycol, neopentyl glycol, hexamethylene glycol or of bisphenol A, and 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, triallyl phosphate, triallyl isocyanurate or tris(2-acryloylethyl) isocyanurate.

Examples of polyunsaturated compounds of relatively high molecular mass (oligomers) are acrylated epoxy resins, polyesters containing acrylate-, vinyl ether- or epoxy-groups, and also polyurethanes and polyethers. Further examples of unsaturated oligomers are unsaturated polyester resins, which are usually prepared from maleic acid, phthalic acid and one or more diols and have molecular weights of from about 500 to 3000. In addition it is also possible to employ vinyl ether monomers and oligomers, and also maleate-terminated oligomers with polyester, polyurethane, polyether, polyvinyl ether and epoxy main chains. Of particular suitability are combinations of oligomers which carry vinyl ether groups and of polymers as described in WO90/01512. However, copolymers of vinyl ether and maleic acid-functionalized monomers are also suitable. Unsaturated oligomers of this kind can also be referred to as prepolymers.

Particularly suitable examples are esters of ethylenically unsaturated carboxylic acids and polyols or polyepoxides, and polymers having ethylenically unsaturated groups in the chain or in side groups, for example unsaturated polyesters, polyamides and polyurethanes and copolymers thereof, polymers and copolymers containing (meth)acrylic groups in side chains, and also mixtures of one or more such polymers.

Examples of unsaturated carboxylic acids are acrylic acid, methacrylic acid, crotonic acid, itaconic acid, cinnamic acid, and unsaturated fatty acids such as linolenic acid or oleic acid. Acrylic and methacrylic acid are preferred.

Suitable polyols are aromatic and, in particular, aliphatic and cycloaliphatic polyols. Examples of aromatic polyols are hydroquinone, 4,4′-dihydroxydiphenyl, 2,2-di(4-hydroxyphenyl)propane, and also novolaks and resols. Examples of polyepoxides are those based on the abovementioned polyols, especially the aromatic polyols, and epichlorohydrin. Other suitable polyols are polymers and copolymers containing hydroxyl groups in the polymer chain or in side groups, examples being polyvinyl alcohol and copolymers thereof or polyhydroxyalkyl methacrylates or copolymers thereof. Further polyols which are suitable are oligoesters having hydroxyl end groups.

Examples of aliphatic and cycloaliphatic polyols are alkylenediols having preferably 2 to 12 C atoms, such as ethylene glycol, 1,2- or 1,3-propanediol, 1,2-, 1,3- or 1,4-butanediol, pentanediol, hexanediol, octanediol, dodecanediol, diethylene glycol, triethylene glcyol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(p-hydroxyethyl)amine, trimethylolethane, trimethylolpropane, pentaerythritol, dipentaerythritol and sorbitol.

The polyols may be partially or completely esterified with one carboxylic acid or with different unsaturated carboxylic acids, and in partial esters the free hydroxyl groups may be modified, for example etherified or esterified with other carboxylic acids.

Examples of esters are: trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, tripropylene glycol diacrylate (TPGDA), dipropylene glycol diacrylate (DPGDA), pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, or mixtures thereof. Also suitable as polymerizable components are triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol, such as, for example, ethoxylated trimethylol propane triacrylate (TMEOPTA).

Also suitable as polymerizable components are the amides of identical or different, unsaturated carboxylic acids with aromatic, cycloaliphatic and aliphatic polyamines having preferably 2 to 6, especially 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-ß-aminoethyl ether, diethylenetriamine, triethylenetetramine, di(ß-aminoethoxy)- or di(ß-aminopropoxy)ethane. Other suitable polyamines are polymers and copolymers, preferably with additional amino groups in the side chain, and oligoamides having amino end groups. Examples of such unsaturated amides are methylenebisacrylamide, 1,6-hexamethylenebisacrylamide, diethylenetriaminetrismethacrylamide, bis(methacrylamidopropoxy)ethane, ß-methacrylamidoethyl methacrylate and N[(ß-hydroxy-ethoxy)ethyl]acrylamide.

Suitable unsaturated polyesters and polyamides are derived, for example, from maleic acid and from diols or diamines. Some of the maleic acid can be replaced by other dicarboxylic acids. They can be used together with ethylenically unsaturated comonomers, for example styrene. The polyesters and polyamides may also be derived from dicarboxylic acids and from ethylenically unsaturated diols or diamines, especially from those with relatively long chains of, for example 6 to 20 C atoms. Examples of polyurethanes are those composed of saturated or unsaturated diisocyanates and of unsaturated or, respectively, saturated diols.

Polymers with (meth)acrylate groups in the side chain are likewise known. They may, for example, be reaction products of epoxy resins based on novolaks with (meth)acrylic acid, or may be homo- or copolymers of vinyl alcohol or hydroxyalkyl derivatives thereof which are esterified with (meth)acrylic acid, or may be homo- and copolymers of (meth)acrylates which are esterified with hydroxyalkyl (meth)acrylates.

Other suitable polymers with acrylate or methacrylate groups in the side chains are, for example, solvent soluble or alkaline soluble polyimide precursors, for example poly(amic acid ester) compounds, having the photopolymerizable side groups either attached to the backbone or to the ester groups in the molecule, i.e. according to EP624826. Such oligomers or polymers can be formulated with optionally reactive diluents, like polyfunctional (meth)acrylates in order to prepare highly sensitive polyimide precursor resists.

Examples of polymerizable component are also polymers or oligomers having at least two ethylenically unsaturated groups and at least one carboxyl function within the molecule structure, such as a resin obtained by the reaction of a saturated or unsaturated polybasic acid anhy-dride with a product of the reaction of an epoxy compound and an unsaturated monocarboxylic acid, for example, photosensitive compounds as described in JP 10-301276 and commercial products such as for example EB9696, UCB Chemicals; KAYARAD TCR1025, Nippon Kayaku Co., LTD., NK OLIGO EA-6340, EA-7440 from Shin-Nakamura Chemical Co., Ltd., or an addition product formed between a carboxyl group-containing resin and an unsaturated compound having an α,β-unsaturated double bond and an epoxy group (for example, ACA200M, Daicel Industries, Ltd.). Additional commercial products as examples of polymerizable component are ACA200, ACA210P, ACA230AA, ACA250, ACA300, ACA320 from Daicel Chemical Industries, Ltd.

The polymerizable compound, may also comprise urethane (meth)acrylates, epoxy (meth)acrylates or carbonate (meth)acrylates.

Urethane (meth)acrylates are obtainable for example by reacting polyisocyanates with hydroxyalkyl (meth)acrylates and optionally chain extenders such as diols, polyols, diamines, polyamines, dithiols or polythiols.

The urethane (meth)acrylates preferably have a number-average molar weight Mₙ of 500 to 20 000, in particular of 500 to 10 000 and more preferably 600 to 3000 g/mol (determined by gel permeation chromatography using tetrahydrofuran and polystyrene as standard).

The urethane (meth)acrylates preferably have a (meth)acrylic group content of 1 to 5, more preferably of 2 to 4, mol per 1000 g of urethane (meth)acrylate.

Epoxy (meth)acrylates are obtainable by reacting epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of possible epoxidized olefins include ethylene oxide, propylene oxide, iso-butylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

The epoxy (meth)acrylates preferably have a number-average molar weight Mₙ of 200 to 20 000, more preferably of 200 to 10 000 g/mol, and very preferably of 250 to 3000 g/mol; the amount of (meth)acrylic groups is preferably 1 to 5, more preferably 2 to 4, per 1000 g of epoxy (meth)acrylate (determined by gel permeation chromatography using polystyrene as standard and tetrahydrofuran as eluent).

Carbonate (meth)acrylates comprise on average preferably 1 to 5, especially 2 to 4, more preferably 2 to 3 (meth)acrylic groups, and very preferably 2 (meth)acrylic groups.

The number-average molecular weight M of the carbonate (meth)acrylates is preferably less than 3000 g/mol, more preferably less than 1500 g/mol, very preferably less than 800 g/mol (determined by gel permeation chromatography using polystyrene as standard, tetrahydrofuran as solvent).

The carbonate (meth)acrylates are obtainable in a simple manner by transesterifying carbonic esters with polyhydric, preferably dihydric, alcohols (diols, hexanediol for example) and subsequently esterifying the free OH groups with (meth)acrylic acid, or else by transesterification with (meth)acrylic esters, as described for example in EP-A 92 269. They are also obtainable by reacting phosgene, urea derivatives with polyhydric, e.g., dihydric, alcohols.

Also conceivable are (meth)acrylates of polycarbonate polyols, such as the reaction product of one of the aforementioned diols or polyols and a carbonic ester and also a hydroxyl-containing (meth)acrylate.

Examples of suitable carbonic esters include ethylene carbonate, 1,2- or 1,3-propylene carbonate, dimethyl carbonate, diethyl carbonate or dibutyl carbonate.

Examples of suitable hydroxyl-containing (meth)acrylates are 2-hydroxyethyl (meth)acrylate, 2- or 3-hydroxypropyl (meth)acrylate, 1,4-butanediol mono(meth)acrylate, neopentyl glycol mono(meth)acrylate, glyceryl mono- and di(meth)acrylate, trimethylolpropane mono- and di(meth)acrylate, and pentaerythritol mono-, di-, and tri(meth)acrylate.

Particularly preferred carbonate (meth)acrylates are those of the formula:

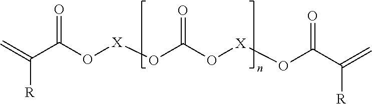

in which R is H or CH₃, X is a C₂-C₁₈ alkylene group, and n is an integer from 1 to 5, preferably 1 to 3.

R is preferably H and X is preferably C2 to C₁₀ alkylene, examples being 1,2-ethylene, 1,2-propylene, 1,3-propylene, 1,4-butylene, and 1,6-hexylene, more preferably C4 to C alkylene. With very particular preference X is C alkylene.

The carbonate (meth)acrylates are preferably aliphatic carbonate (meth)acrylates.

As diluent, a mono- or multi-functional ethylenically unsaturated compound, or mixtures of several of said compounds, can be included in the above composition up to 70% by weight based on the solid portion of the composition.

The invention also provides compositions comprising as polymerizable component at least one ethylenically unsaturated photopolymerizable compound which is emulsified or dissolved in water, or organic solvents.

The unsaturated polymerizable components can also be used in admixture with non-photopolymerizable, film-forming components. These may, for example, be physically drying polymers or solutions thereof in organic solvents, for instance nitrocellulose or cellulose acetobutyrate. They may also, however, be chemically and/or thermally curable (heat-curable) resins, examples being polyisocyanates, polyepoxides and melamine resins, as well as polyimide precursors. The use of heat-curable resins at the same time is important for use in systems known as hybrid systems, which in a first stage are photopolymerized and in a second stage are crosslinked by means of thermal aftertreatment.

The UV curable composition comprises

(a) 1.0 to 20.0, especially 1.0 to 15.0, very especially 3.0 to 10.0% by weight of photoinitiator,
(b) 99.0 to 80.0, especially 99.0 to 85.0, very especially 97.0 to 90.0% by weight of a binder (unsaturated compound(s) including one or more olefinic double bonds),
wherein the sum of components a) and b) adds up to 100%.

In a preferred embodiment the UV curable composition comprises an epoxy-acrylate (10 to 60%) and one or several (monofunctional and multifunctional) acrylates (20 to 90%) and one, or several photoinitiators (1 to 15%).

The epoxy-acrylate is selected from aromatic glycidyl ethers aliphatic glycidyl ethers. Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]). Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

The one or several acrylates are preferably multifunctional monomers which are selected from trimethylolpropane triacrylate, trimethylolethane triacrylate, trimethylolpropane trimethacry¬late, trimethylolethane trimethacrylate, tetramethylene glycol dimethacrylate, triethylene gly¬col dimethacrylate, tetraethylene glycol diacrylate, tripropylene glycol diacrylate (TPGDA), dipropylene glycol diacrylate (DPGDA), pentaerythritol diacrylate, pentaerythritol triacrylate, pentaerythritol tetraacrylate, dipentaerythritol diacrylate, dipentaerythritol triacry¬late, dipentaerythritol tetraacrylate, dipentaerythritol pentaacrylate, dipentaerythritol hexa¬acrylate, tripentaerythritol octaacrylate, pentaerythritol dimethacrylate, pentaerythritol trimeth¬acrylate, dipentaerythritol dimethacrylate, dipentaerythritol tetramethacrylate, tripenta¬erythritol octamethacrylate, pentaerythritol diitaconate, dipentaerythritol tris-itaconate, dipen¬taerythritol pentaitaconate, dipentaerythritol hexaitaconate, ethylene glycol diacrylate, 1,3-bu¬tanediol diacrylate, 1,3-butanediol dimethacrylate, 1,4-butanediol diitaconate, sorbitol triacryl¬ate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol, such as, for example, ethoxylated trimethylol propane triacrylate (TMEOPTA) and or mixtures thereof.

The photoinitiator is preferably a blend of an alpha-hydroxy ketone, alpha-alkoxyketone or alpha-aminoketone compound of the formula (XI) and a benzophenone compound of the formula (X); or a blend of an alpha-hydroxy ketone, alpha-alkoxyketone or alpha-aminoketone compound of the formula (XI), a benzophenone compound of the formula (X) and an acylphosphine oxide compound of the formula (XII).

In another preferred embodiment the UV curable composition comprises:

| | |
|---|---|
| Bisphenol A epoxyacrylate with 25% TPGDA | 1-35% by weight |
| Dipropylene glycol diacrylate (DPGDA) | 30-45% by weight |
| Ethoxylated trimethylol propane triacrylate | 10-50% by weight |
| (TMEOPTA) | |
| Reactive tertiary amine | 1-15% by weight |
| Photoinitiator: | 5-10% by weight |

In another preferred embodiment the UV curable composition comprises:

| | |
|---|---|
| Tripropylene glycol diacrylate (TPGDA) | 1-25% by weight |
| Dipropylene glycol diacrylate (DPGDA) | 30-45% by weight |
| Ethoxylated trimethylol propane triacrylate | 10-50% by weight |
| (TMEOPTA) | |
| Reactive tertiary amine | 1-15% by weight |
| Photoinitiator: | 5-9% by weight |

The photoinitiator is preferably a blend of an alpha-hydroxy ketone, alpha-alkoxyketone or alpha-aminoketone compound of the formula (XI) and a benzophenone compound of the formula (X); or a blend of an alpha-hydroxy ketone, alpha-alkoxyketone or alpha-aminoketone compound of the formula (XI), a benzophenone compound of the formula (X) and an acylphosphine oxide compound of the formula (XII).

The curable composition may comprise various additives. Examples thereof include thermal inhibitors, coinitiators and/or sensitizers, light stabilisers, optical brighteners, fillers and pigments, as well as white and coloured pigments, dyes, antistatics, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, leveling agents and other adjuvants customary, for example, in lacquer, ink and coating technology.

Examples of coinitiators/sensitisers are especially aromatic carbonyl compounds, for example benzophenone, thioxanthone, especially isopropyl thioxanthone, anthraquinone and 3-acylcoumarin derivatives, terphenyls, styryl ketones, and also 3-(aroylmethylene)-thiazolines, camphor quinone, and also eosine, rhodamine and erythrosine dyes. Amines, for example, can also be regarded as photosensitisers when the photoinitiator consists of a benzophenone or benzophenone derivative.

Examples of light stabilizers are:

Phosphites and phosphonites (processing stabilizer), for example triphenyl phosphite, diphenylalkyl phosphites, phenyldialkyl phosphites, tris(nonylphenyl) phosphite, trilauryl phosphite, trioctadecylphosphite, distearylpentaerythritoldiphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritoldiphosphite, diisodecyloxypentaerythritoldiphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS No. 939402-02-5), Phosphorous acid, triphenyl ester, polymer with alpha-hydro-omega-hydroxypoly[oxy(methyl-1,2-ethanediyl)], C₁₀₋₁₆ alkyl esters (CAS No. 1227937-46-3). The following phosphites are especially preferred: Tris(2,4-di-tert-butylphenyl) phosphite, tris(nonylphenyl) phosphite,

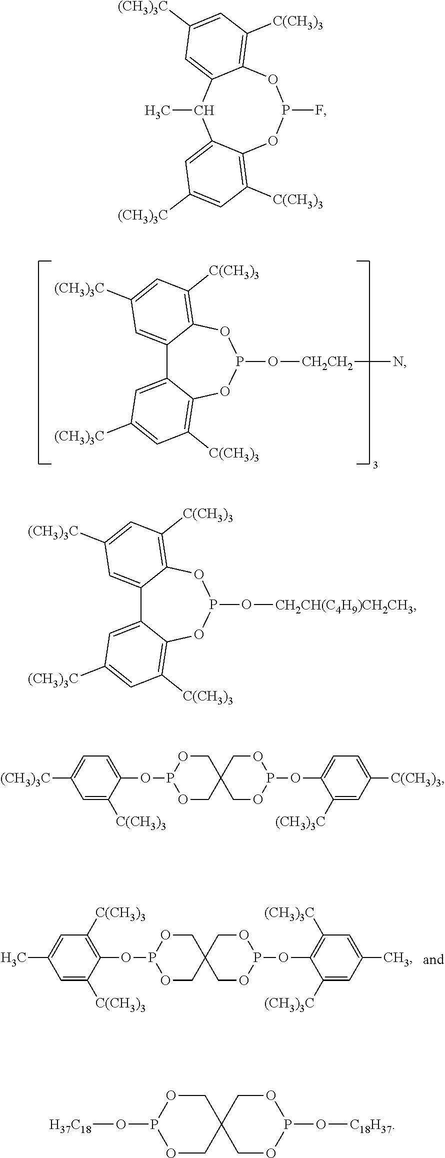

### Quinone Methides of the Formula

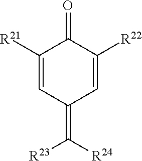

(providing long term shelf life stability), wherein
R²¹ and R²² independently of each other are C₁-C₁₈alkyl, C₅-C₁₂cycloalkyl, C₇-C₁₅-phenylalkyl, optionally substituted C₆-C₁₀aryl;
R²³ and R²⁴ independently of each other are H, optionally substituted C₆-C₁₀-aryl, 2-,3-,4-pyridyl, 2-,3-furyl or thienyl, COOH, COOR²⁵, CONH₂, CONHR²⁵, CONR²⁵R²⁶, —CN, —COR²⁵, —OCOR²⁵, —OPO(OR²⁵)₂, wherein R²⁵ and R²⁶ are independently of each other C₁-C₈alkyl, or phenyl. Quinone methides are preferred, wherein R²¹ and R²² are tert-butyl;
R²³ is H, and R²⁴ is optionally substituted phenyl, COOH, COOR²⁵, CONH₂, CONHR²⁵, CONR²⁵R²⁶, —CN, —COR²⁵, —OCOR²⁵, —OPO(OR²⁵)₂, wherein R²⁵ and R²⁶ are C₁-C₈alkyl, or phenyl. Examples of quinone methides are

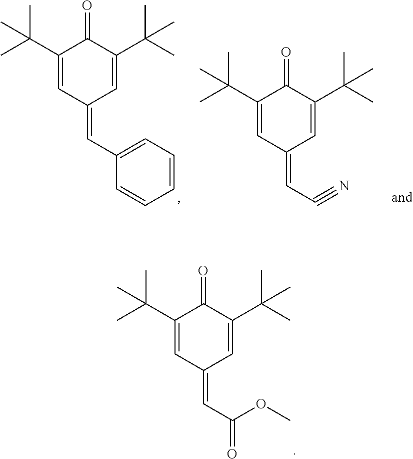

The quinone methides may be used in combination with highly sterically hindered nitroxyl radicals as described, for example, in US20110319535.

The quinone methides are used typically in a proportion of from about 0.01 to 0.3% by weight, preferably from about 0.04 to 0.15% by weight, based on the total weight of the UV curable composition.

Leveling agents used, which additionally also serve to improve scratch resistance, can be the products TEGO® Rad 2100, TEGO® Rad 2200, TEGO® Rad 2300, TEGO® Rad 2500, TEGO® Rad 2600, TEGO® Rad 2700 and TEGO® Twin 4000, likewise obtainable from Tego. Such auxiliaries are obtainable from BYK, for example as BYK®-300, BYK®-306, BYK®-307, BYK®-310, BYK®-320, BYK®-322, BYK®-331, BYK®-333, BYK®-337, BYK®-341, Byk® 354, Byk® 361 N, BYK®-378 and BYK®-388.

Leveling agents are typically used in a proportion of from about 0.005 to 1.0% by weight, preferably from about 0.01 to 0.2% by weight, based on the total weight of the UV curable composition.

In a further embodiment of the present invention the ultraviolet coating can be coloured. That is the curable composition may comprise pigments and/or dyes. The pigments can be transparent organic color pigments or inorganic pigments.

Suitable colored pigments especially include organic pigments selected from the group consisting of azo, azomethine, methine, anthraquinone, phthalocyanine, perinone, perylene, diketopyrrolopyrrole, thioindigo, dioxazine iminoisoindoline, dioxazine, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Colored organic pigments of particular interest include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, the 2,9-dichloro-quinacridone in platelet form described in WO08/055807, or a mixture or solid solution thereof.

Plateletlike organic pigments, such as plateletlike quinacridones, phthalocyanine, fluororubine, dioxazines, red perylenes or diketopyrrolopyrroles can advantageously be used as component B.

Suitable colored pigments also include conventional inorganic pigments; especially those selected from the group consisting of metal oxides, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate, Prussian blue, Fe₃O₄, carbon black and mixed metal oxides. Examples of commercially available inorganic pigments are BAYFERROX® 3920, BAYFERROX®920, BAYFERROX® 645T, BAYFERROX® 303T, BAYFERROX® 110, BAYFERROX® 110 M, CHROMOXIDGRUEN GN, and CHROMOXIDGRUEN GN-M.

Examples of dyes, which can be used to color the curable composition, are selected from the group consisting of azo, azomethine, methine, anthraquinone, phthalocyanine, dioxazine, flavanthrone, indanthrone, anthrapyrimidine and metal complex dyes. Monoazo dyes, cobalt complex dyes, chrome complex dyes, anthraquinone dyes and copper phthalocyanine dyes are preferred.

The OVD of the present invention may either comprise a metallic layer, or layer of the transparent high reflective index (HRI) material on the cured embossed film. The metal and the HRI material may be applied in step i) by vacuum deposition, but are preferably applied to the embossed layer by means of conventional printing press such as gravure, rotogravure, flexographic, lithographic, offset, letterpress intaglio and/or screen process, or other printing process.

The OVD may be coated with a thin film of transparent material having a high refractive index (HRI). Examples are transparent polymers having greater refractive index than the hologram forming layer (i=ca. 1.50), such as, for example, PEI (polyetherimide; 1=1.65-1.77) PEEK (polyetheretherketone; n=1.66-1.67), and polysulfones (n=1.63-1.65). In addition, extrinsic high refractive index polymers result by incorporation of high refractive index materials, especially nanoparticles into conventional polymers or intrinsic high refractive index polymers.

The transparent high reflective index material is preferably selected from nanoparticles of polymethylmethacrylat (PMMA), ZnS, ZnO, Si, Sb₂S₃, Fe₂O₃, PbO, PbS, ZnSe, CdS, TiO₂, PbCl₂, CeO₂, Ta₂O₅, ZnO, CdO, and Nd₂O₃, wherein nanoparticles of PMMA, nanoparticles of TiO₂ and platelets of ZnS are preferred. Substrates coated with a transparent HRI coating are often used for security applications such as identification or access cards, where it is desired that information positioned behind the hologram remains visible to the unaided eye.

The HRI material based ink may comprise metal pigment particles, a solvent and optionally a binder. Reference is made, for example, to European patent application no. 17182268.7.

The solvent is preferably selected from water, alcohols (such as methanol, ethanol, 1-propanol, 2-propanol, 1-butanol, 2-butanol, isobutanol, tert-butanol, tert-pentanol), cyclic or acyclic ethers (such as diethyl ether, tetrahydrofuran and 2-methyltetrahydrofurane), ketones (such as acetone, 2-butanone, 3-pentanone), ether-alcohols (such as 2-methoxyethanol, 1-methoxy-2-propanol, ethylene glycol monobutyl ether, diethylene glycol monoethyl ether, diethylene glycol monopropyl ether, and diethylene glycol monobutyl ether), esters (such as ethyl acetate, ethyl propionate, and ethyl 3-ethoxypropionate) and mixtures thereof.

Volatile primary or secondary alcohols, like ethanol and iso-propanol are most preferred.

The amount of solvent in the (coating or printing ink) composition is dependent on the coating process, printing process etc. For gravure printing the solvent may be present in the printing ink composition in an amount of from 80 to 97% by weight of the printing ink composition, preferably 90 to 95% by weight.

The printing ink compositions may comprise a binder. Generally, the binder is a high-molecular-weight organic compound conventionally used in coating compositions. High molecular weight organic materials usually have molecular weights of about from 103 to 108 g/mol or even more. They may be, for example, natural resins, drying oils, rubber or casein, or natural substances derived therefrom, such as chlorinated rubber, oil-modified alkyd resins, viscose, cellulose ethers or esters, such as ethylcellulose, cellulose acetate, cellulose propionate, cellulose acetobutyrate or nitrocellulose, but especially totally synthetic organic polymers (thermosetting plastics and thermoplastics), as are obtained by polymerisation, polycondensation or polyaddition. From the class of the polymerisation resins there may be mentioned, especially, polyolefins, such as polyethylene, polypropylene or polyisobutylene, and also substituted polyolefins, such as polymerisation products of vinyl chloride, vinyl acetate, styrene, acrylonitrile, acrylic acid esters, methacrylic acid esters or butadiene, and also copolymerisation products of the said monomers, such as especially ABS or EVA.

With respect to the binder resin, a thermoplastic resin may be used, examples of which include, polyethylene based polymers [polyethylene (PE), ethylene-vinyl acetate copolymer (EVA), vinyl chloride-vinyl acetate copolymer, vinyl alcohol-vinyl acetate copolymer, polypropylene (PP), vinyl based polymers [poly(vinyl chloride) (PVC), poly(vinyl butyral) (PVB), poly(vinyl alcohol) (PVA), poly(vinylidene chloride) (PVdC), poly(vinyl acetate) (PVAc), poly(vinyl formal) (PVF)], polystyrene based polymers [polystyrene (PS), styrene-acrylonitrile copolymer (AS), acrylonitrile-butadiene-styrene copolymer (ABS)], acrylic based polymers [poly(methyl methacrylate) (PMMA), MMA-styrene copolymer], polycarbonate (PC), celluloses [ethyl cellulose (EC), cellulose acetate (CA), propyl cellulose (CP), cellulose acetate butyrate (CAB), cellulose nitrate (CN), also known as nitrocellulose], fluorin based polymers [polychlorofluoroethylene (PCTFE), polytetrafluoroethylene (PTFE), tetrafluoroethylene-hexafluoroethylene copolymer (FEP), poly(vinylidene fluoride) (PVdF)], urethane based polymers (PU), nylons [type 6, type 66, type 610, type 11], polyesters (alkyl) [polyethylene terephthalate (PET), polybutylene terephthalate (PBT), polycyclohexane terephthalate (PCT)], novolac type phenolic resins, or the like. In addition, thermosetting resins such as resol type phenolic resin, a urea resin, a melamine resin, a polyurethane resin, an epoxy resin, an unsaturated polyester and the like, and natural resins such as protein, gum, shellac, copal, starch and rosin may also be used.

The binder preferably comprises nitrocellulose, ethyl cellulose, cellulose acetate, cellulose acetate propionate (CAP), cellulose acetate butyrate (CAB), hydroxyethyl cellulose (HEC), hydroxypropyl cellulose (HPC), alcohol soluble propionate (ASP), vinyl chloride, vinyl acetate copolymers, vinyl acetate, vinyl, acrylic, polyurethane, polyamide, rosin ester, hydrocarbon, aldehyde, ketone, urethane, polythyleneterephthalate, terpene phenol, polyolefin, silicone, cellulose, polyamide, polyester, rosin ester resins, shellac and mixtures thereof, most preferred are soluble cellulose derivatives such as hydroxylethyl cellulose, hydroxypropyl cellulose, nitrocellulose, carboxymethylcellulose as well as chitosan and agarose, in particular hydroxyethyl cellulose and hydroxypropyl cellulose.

The metal-based ink may comprise metal pigment particles, a binder and optionally a solvent.

The metal pigment particles may comprise any suitable metal. Nonlimiting examples of suitable metallic materials include aluminum, silver, copper, gold, platinum, tin, titanium, palladium, nickel, cobalt, rhodium, niobium, stainless steel, nichrome, chromium, and compounds, combinations or alloys thereof. The particles may comprise any one or more selected from the group comprising aluminium, gold, silver, platinum and copper. Preferably, the particles comprise aluminium, silver and/or copper flakes.

In a preferred embodiment of the present invention, platelet shaped transition metal particles of silver, platinum and copper having a longest dimension of edge length of from 15 nm to 1000 nm, preferably from 15 nm to 600 nm and particularly from 20 nm to 500 nm, and a thickness of from 2 nm to 100 nm, preferably from 2 to 40 nm and particularly from 4 to 30 nm are used. The production of the shaped transition metal particles is, for example, described in US2008/0295646, WO2004/089813, WO2006/099312, C. Xue et al., Adv. Mater. 19, 2007, 4071, WO2009056401 and WO2010/108837. The use of the platelet shaped transition metal particles for producing holograms is described in WO2011/064162. The inks comprise a total content of shaped transition metal particles of from 0.1 to 90% by weight, preferably 0.1-70% by weight based on the total weight of the ink. Preferably, the binder comprises 50% nitrocellulose in conjunction with any below mentioned resin. The ink may additionally comprise a solvent. The solvent may be ester/alcohol blends and preferably normal propyl acetate and ethanol. More preferably, the ester/alcohol blend is in a ratio of between 10:1 and 40:1, even more preferably 20:1 to 30:1. The solvent used in the metallic ink may comprise any one or more of an ester, such as n-propyl acetate, iso-propyl acetate, ethyl acetate, butyl acetate; an alcohol, such as ethyl alcohol, industrial methylated spirits, isopropyl alcohol or normal propyl alcohol; a ketone, such as methyl ethyl ketone or acetone; an aromatic hydrocarbon, such as toluene, and water.

The platelet shaped (transition) metal particles may be used in combination with spherical (transition) metal particles. Alternatively, spherical (transition) metal particles having a diameter of ≤40 nm, especially ≤20 nm may be used alone.

In addition, the silver nanoparticle containing layers may be produced by the methods described in WO2016170160 and European patent application no. 17170968.6 and 17183732.1.

In another preferred embodiment the metal pigment is selected from aluminium, stainless steel, nichrome, gold, silver, platinum or any other metal which can be vaporised and deposited by vacuum deposition or applied by sputtering or electron beam deposition.

Preferably, the metal pigment is aluminium and is produced by physical vapor deposition (PVD). The thickness of the metal particles is in the range of 5 to 50 nm, especially 8 to 21 nm. The average particle diameter may be in the range of 8 to 15 microns, the preferred range being 9 to 10 microns diameter as measured by a Coulter LS130 l.a.s.e.r. diffraction granulometer.

An example of a metallic ink suitable for use in the methods of the present invention is disclosed in WO05/051675, WO2005049745 and WO2010/069823.

The ink comprises, as in the case of an ordinary printing ink, the metal flakes, especially aluminium flakes, a binder, an auxiliary agent, and the like.

A photopolymerization-curable resin or an electron beam curable resin wherein a solvent is not used may also be employed as a binder resin that is a principal component of the vehicle. The examples thereof include an acrylic resin, and specific examples of acrylic monomers commercially available are shown below.

A monofunctional acrylate monomer that may be used includes for example, 2-ethylhexyl acrylate, 2-ethylhexyl-EO adduct acrylate, ethoxydiethylene glycol acrylate, 2-hydroxyethyl acrylate, 2-hydroxypropyl acrylate, 2-hydroxyethyl acrylate-caprolactone addduct, 2-phenoxyethyl acrylate, phenoxydiethylene glycol acrylate, nonyl phenol-EO adduct acrylate, (nonyl phenol-EO adduct)-caprolactone adduct acrylate, 2-hydroxy-3-phenoxypropyl acrylate, tetrahydrofurfuryl acrylate, furfuryl alcohol-caprolactone adduct acrylate, acryloyl morpholine, dicyclopentenyl acrylate, dicyclopentanyl acrylate, dicyclopentenyloxyethyl acrylate, isobornyl acrylate, (4,4-dimethyl-1,3-dioxane)-caprolactone adduct acrylate, (3-methyl-5,5-dimethyl-1,3-dioxane)-caprolactone adduct acrylate, and the like.

A polyfunctional acrylate monomer that may be used includes hexanediol diacrylate, neopentyl glycol diacrylate, polyethylene glycol diacrylate, tripropylene glycol diacrylate, neopentyl glycol hydroxypivalate diacrylate, (neopentyl glycol hydroxypivalate)-caprolactone adduct diacrylate, (1,6-hexanediol diglycidyl ether)-acrylic acid adduct, (hydroxypivalaldehyde-trimethylolpropane acetal) diacrylate, 2,2-bis[4-(acryloyloxydiethoxy)phenyl]propane, 2,2-bis[4-(acryloyloxydiethoxy)phenyl]methane, hydrogenated bisphenol A-ethylene oxide adduct diacrylate, tricyclodecanedimethanol diacrylate, trimethylolpropane triacrylate, pentaerithritol triacrylate, (trimethylolpropane-propylene oxide) adduct triacrylate, glycerine-propylene oxide adduct triacrylate, a mixture of dipentaerithritol hexaacrylate and pentaacrylate, esters of dipentaerithritol and lower fatty acid and acrylic acid, dipentaerithritol-caprolactone adduct acrylate, tris(acryloyloxyethyl) isocyanurate, 2-acryloyloxyethyl phosphate, and the like.

Inks comprising the above resins are free of solvent and are so constituted as to polymerize in chain reaction upon irradiation by an electron beam or electromagnetic waves.

With respect to inks of ultraviolet-irradiation type among these inks, a photopolymerization initiator, and depending on the needs therefor, a sensitizing agent, and auxiliary agents such as a polymerization inhibitor and a chain transfer agent, and the like may be added thereto.

With respect to photo-polymerization initiators, there are, (1) an initiator of direct photolysis type including an arylalkyl ketone, an oxime ketone, an acylphosphine oxide, or the like, (2) an initiator of radical polymerization reaction type including a benzophenone derivative, a thioxanthone derivative, or the like, (3) an initiator of cationic polymerization reaction type including an aryl diazonium salt, an aryl iodinium salt, an aryl sulfonium salt, and an aryl acetophenone salt, or the like, and in addition, (4) an initiator of energy transfer type, (5) an initiator of photoredox type, (6) an initiator of electron transfer type, and the like. With respect to the inks of electron beam-curable type, a photopolymerization initiator is not necessary and a resin of the same type as in the case of the ultraviolet-irradiation type inks can be used, and various kinds of auxiliary agent may be added thereto according to the needs therefor.

In addition, with respect to the binder resin, a thermoplastic resin may be used, examples of which include, polyethylene based polymers [polyethylene (PE), ethylene-vinyl acetate copolymer (EVA), vinyl chloride-vinyl acetate copolymer, vinyl alcohol-vinyl acetate copolymer, polypropylene (PP), vinyl based polymers [poly(vinyl chloride) (PVC), poly(vinyl butyral) (PVB), poly(vinyl alcohol) (PVA), poly(vinylidene chloride) (PVdC), poly(vinyl acetate) (PVAc), poly(vinyl formal) (PVF)], polystyrene based polymers [polystyrene (PS), styrene-acrylonitrile copolymer (AS), acrylonitrile-butadiene-styrene copolymer (ABS)], acrylic based polymers [poly(methyl methacrylate) (PMMA), MMA-styrene copolymer], polycarbonate (PC), celluloses [ethyl cellulose (EC), cellulose acetate (CA), propyl cellulose (CP), cellulose acetate butyrate (CAB), cellulose nitrate (CN)], fluorin based polymers [polychlorofluoroethylene (PCTFE), polytetrafluoroethylene (PTFE), tetrafluoroethylene-hexafluoroethylene copolymer (FEP), poly(vinylidene fluoride) (PVdF)], urethane based polymers (PU), nylons [type 6, type 66, type 610, type 11], polyesters (alkyl) [polyethylene terephthalate (PET), polybutylene terephthalate (PBT), polycyclohexane terephthalate (PCT)], novolac type phenolic resins, or the like. In addition, thermosetting resins such as resol type phenolic resin, a urea resin, a melamine resin, a polyurethane resin, an epoxy resin, an unsaturated polyester and the like, and natural resins such as protein, gum, shellac, copal, starch and rosin may also be used.

Furthermore, to the binder, a plasticizer for stabilizing the flexibility and strength of the print film and a solvent for adjusting the viscosity and drying property thereof may be added according to the needs therefor. The solvent may comprise any one or more of an ester, such as n-propyl acetate, iso-propyl acetate, ethyl acetate, butyl acetate; an alcohol, such as ethyl alcohol, industrial methylated spirits, isopropyl alcohol or normal propyl alcohol; a ketone, such as methyl ethyl ketone or acetone; an aromatic hydrocarbon, such as xylene and toluene. A solvent of a low boiling temperature of about 100° C. and a petroleum solvent of a high boiling temperature of 250° C. or higher, may be used according to the type of the printing method. An alkylbenzene or the like, for example may be used as a solvent of a low boiling temperature. Examples of solvents are ethoxypropanol, methylethylketon, methoxypropylacetate, diacetonalcohol etc.

The binder may comprise any one or more selected from the group comprising nitro cellulose, vinyl chloride, vinyl acetate copolymers, vinyl, acrylic, urethane, polythyleneterephthalate, terpene phenol, polyolefin, silicone, cellulose, polyamide, rosin ester resins. The preferred binder is 50% nitrocellulose (ID nitrocellulose DHL120/170 and nitrocellulose DLX30/50 supplied by Nobel Industries) 50% polyurethane (ID Neorez U335 supplied by Avecia). The solvents may be ester/alcohol blends and preferably normal propyl acetate and ethanol in a ratio of 20:1 to 30:1.

Preferably, the pigment to binder ratio is in the range of 10:1 to 1:10 by weight. More preferably, the pigment to binder ratio is by weight in the range of 6:1 to 1:6, and even more preferably 4:1 to 1:4. Most preferably the pigment to binder ratio is from 3:1 to 1:3.

Further in addition, an auxiliary agent including a variety of reactive agents for improving drying property, viscosity, and dispersibility, may suitably be added. The auxiliary agents are to adjust the performance of the ink, and for example, a compound that improves the abrasion resistance of the ink surface and a drying agent that accelerates the drying of the ink, and the like may be employed.

The inks comprise a total content of metal, especially aluminum pigment of from 0.1 to 20% by weight, preferably 0.1-10% by weight based on the total weight of the ink. The metal pigment content by weight of the composition may be less than 10%. Preferably the pigment content by weight of the composition is less than 6%, more preferably in the range of 0.1% to 6%, even more preferably in the range 0.1% to 3%, more preferably still in the range 0.2% to 2% by weight. In another embodiment of the present invention the metal pigment content of the ink may be the range of 2% to 4% by weight, and preferably 3%.

Preferably, the thickness of the metallic ink when deposited on a substrate is sufficiently thin as to permit the transmission of light therethrough. Preferably, when the substrate carrying the metallised image or pattern is subsequently over-laid onto printed pictures and/or text, or the substrate is pre-printed with pictures and/or text and the metallised image or pattern is deposited thereon those printed features are visible through the metallic ink coated optically variable image or device.

In addition, the present invention relates to (security) elements, which comprise

a flexible substrate,
a primer layer and
an embossed film, and are obtainable by the process according to the invention.

The security element may comprise one, or more further layers, which are selected from black layers, white layers, metallic layers, plasmonic layers, liquid crystalline layers, magnetic layers, fluorescent layers, interference layers, plasmonic layers, colored layers, IR-absorbing layers, IR-transparent layers and conductive layers. The layers might be fully, or partially printed on the security element.

The security element, might be part of a security document. Accordingly, the present invention is directed to a security document, comprising the security element of the present invention as a laminate onto the document or embedded as a (windowed) thread into the document or as a window on the document.

The production of window threads is, for example, described in EP319157, WO14108329 and WO03054297.

The security document can be, for example, a banknote, tax stamp, ID-card, voucher, entrance ticket, or label.

Various aspects and features of the present invention will be further discussed in terms of the examples. The following examples are intended to illustrate various aspects and features of the present invention.

### EXAMPLES

Primer Formulation:

| Compound | Weight (g) |
|---|---|
| Photoinitiator¹⁾ | 6.07 |
| Sartomer ® 344 (polyethylene glycol (400) diacrylate) | 3.45 |
| Isopropanol | 495.24 |
| 1,2-dimethoxypropanol | 495.24 |

¹⁾Compound of formula (V), wherein n is 1, and R¹¹ is a group of formula

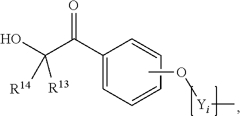

in which R¹³ and R¹⁴ each independently of one another are an alkyl group containing 1 to 4 carbon atoms, Yᵢ for is a group of —CH₂—CH₂—O—, —CH₂—CH(CH₃)—O—, and —CH(CH₃)—CH₂—O—, preferably —CH₂—CH₂—O—.

The UV curable composition is shown below:

| UV curable composition | % by weight |
|---|---|
| Bisphenol A epoxyacrylate with 25% TPGDA | 1-35 |
| Dipropylene glycol diacrylate (DPGDA) | 30-45 |
| Ethoxylated trimethylol propane triacrylate (TMEOPTA) | 10-50 |
| Reactive tertiary amine | 1-15 |
| Photoinitiator blend: | 5-10 |
| Bis(2,4,6-trimethylbenzoyl)phenyl-phosphine oxide/4-phenyl | |
| benzophenone/2-hydroxy-1-{1-[4-(2-hydroxy-2-methyl- | |
| propionyl)-phenyl]-1,3,3-trimethyl-indan-5-yl}-2-methyl- | |
| propan-1-one | |

### Comparative Example 1

Hostaphan® RNK (Mitsubishi), a 23 micron biaxially oriented coextruded film made of polyethylene terephthalate (PET), is corona treated (Softal® CLNE015-130-1KB3) at 300 W min/m² and printed with the UV curable composition. UV casting is done on a nickel shim containing holographic structures using a UV lamp GEW, E2C-35-3 mercury lamp (140 W/cm), 50% power intensity and 5 bar pressure on nip rollers at 30 m/min. The holographic image transfer on PET is assessed visually and the adhesion of the hologram on PET is done with a tape test (Tesa 4104 adhesive)

### Example 1

The primer formulation is printed by gravure using a 3051/cm ceramic cylinder on Hostaphan® RNK, which is corona treated at 300 Watt at 10 m/min speed, press temperature 70° C. and UV cured with an IST lamp 150 Watt/cm mercury lamp.

The PET foil coated with the primer formulation is overprinted with UV curable composition using a 701/cm gravure cylinder and UV casting is done on a nickel shim containing holographic structures using a UV lamp GEW, E2C-35-3 mercury lamp (140 W/cm), 50% power intensity, 5 bar pressure on nip rollers at 30 m/min. The holographic image transfer on PET is assessed visually and the adhesion of the hologram on PET is done with a tape test (Tesa 4104 adhesive)

### Comparative Example 2

Comparative Example 1 is repeated, except that Hostaphan® RNK is replaced by Hostaphan® RD (Mitsubishi), a 19 micron biaxially oriented coextruded film made of polyethylene terephthalate having an antislip treatment on surface.

### Example 2

Example 1 is repeated, except that Hostaphan® RNK is replaced by Hostaphan® RD.

### Comparative Example 3

Comparative Example 1 is repeated, except that Hostaphan® RNK is replaced by Hostaphan® RLDM (Mitsubishi), a 19 micron biaxially oriented coextruded film made of polyethylene terephthalate having an extremely flat surface and modified shrinking properties.

### Example 3

Example 1 is repeated, except that Hostaphan® RNK is replaced by Hostaphan® RLDM.

### Comparative Example 4

Comparative Example 1 is repeated, except that Hostaphan® RNK is replaced by Melinex® 4000 W (DuPont, Teijin Films), a 50 micron low cost polyethylene terephthalate.

### Example 4

Example 1 is repeated, except that Hostaphan® RNK is replaced by Melinex® 400CW.

TABLE 1
Assessment of holographic image transfer and adhesion of the
hologram to substrate

| | | | Transfer of UV |
|---|---|---|---|
| Sample of | Treatment | Tape test | casted holograms |
| Comparative Example 1 | corona | bad | poor |
| Example 1 | corona/primer | good | good |
| Comparative Example 2 | corona | bad | poor |
| Example 2 | corona/primer | good | good |
| Comparative Example 3 | corona | bad | poor |
| Example 3 | corona/primer | good | good |
| Comparative Example 4 | corona | bad | poor |
| Example 4 | corona/primer | good | good |

A bad hologram transfer is observed in case of only corona treatment with all tested films. The UV casted hologram is sticking on the shim. No or very poor hologram transfer is visible on filmic substrates.

A good hologram transfer occurs on the surface of all tested filmic substrates when first the primer formulation is printed. The primer formulation provides strong adhesion properties of UV curable composition on filmic substrates, therefore a good transfer of UV casted holograms at the printing speed is obtained.

Similar results are obtained when the primer formulation is printed with a 701/cm instead of a 3051/cm gravure cylinder

1. A process for producing strongly adherent films on a flexible substrate, the process comprising:
(a) optionally exposing the flexible substrate to a corona discharge or a plasma discharge treatment;
(b) applying a primer composition on the substrate, the primer composition comprising (b1) a polyurethane (A) comprising as synthesis components (b1a) a polyisocyanate having a functionality of at least 2, (b1b) a compound comprising an isocyanate-reactive group and a radically polymerizable unsaturated group, (b1c) a photoinitiator comprising an isocyanate-reactive group, (b2) a polyfunctional polymerizable compound (B), and (b3) a solvent;
(c) evaporating the solvent by applying IR-radiation and/or thermal drying, to obtain a primer layer on the substrate;
(d) curing the primer layer by UV/VIS radiation or electron beam, to obtain a primered substrate;
(e) optionally, exposing the primered substrate to a corona discharge or a plasma discharge treatment;
(f) applying a curable composition onto the primer coating;
(g) optionally, contacting at least a portion of the curable composition with surface relief micro-structure former, to obtain an optionally embossed film;
(h) curing the optionally embossed film by UV/VIS radiation or electron beam; and
(i) optionally, depositing a layer of a transparent high refractive index material and/or a metallic layer on at least a portion of the cured composition.

2. The process of claim 1, comprising:
(a) exposing the flexible substrate to a corona discharge or a plasma discharge treatment;
(g) contacting at least a portion of the curable composition with surface relief micro-structure former; and
(h) curing the embossed film by UV/VIS radiation.

3. The process of claim 1, wherein the flexible substrate is a biaxially oriented polyethylene terephthalate film or a biaxially oriented polypropylene film.

4. The process of claim 1, wherein the applying (b) comprises slot die-coating, knife-coating, reverse roll-coating, metering rod coating, gravure-printing, flexo-printing, screen-printing, or ink jet printing the primer composition.

5. The process of claim 1, wherein a liquid crystal composition is applied by slot die-coating, knife-coating, reverse roll-coating, metering rod coating, gravure-printing, flexo-printing, screen-printing, or ink jet printing.

6. The process of claim 1, wherein the embossed film is present and has a peelforce >20 N/m.

7. The process of claim 1, wherein the curable composition comprises:
(a) 1.0 to 20.0 wt. % of photoinitiator;
(b) 99.0 to 80.0 wt. % weight of a resin;
wherein a sum of the components (a) and (b) adds up to 100%.

8. The process of claim 1, wherein the polyurethane (A) is a compound of formula 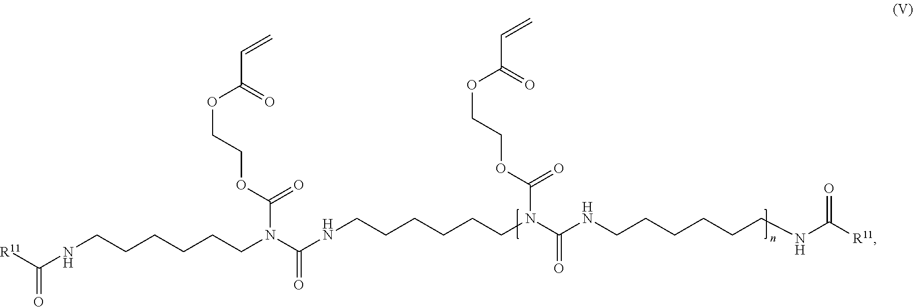
wherein
n is a positive number which is on average 1 up to 5, and
R¹¹ is a group of formula 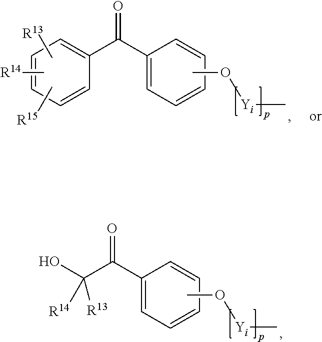
wherein
R¹³, R¹⁴, and R¹⁵ are independently H, an alkyl group comprising 1 to 4 carbon atoms, or an alkyloxy group comprising 1 to 4 carbon atoms,
p is 0 or an integer in a range of from 1 to 10, and
Yᵢ for i=1 to p is independently —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, or —CHPh-CH₂O—, in which Ph is phenyl and Vin is vinyl.

9. The process of claim 8, wherein the polymerizable compound (B) comprises 1,2-propanediol diacrylate, 1,3-propanediol diacrylate, dipropylene glycol diacrylate, tripropylene glycol diacrylate, polyethylene glycol diacrylate, polyethylene glycol dimethacrylate, trimethylolpropane triacrylate, ditrimethylol tetracrylate, dipentaerythritol hexaacrylate, triacrylate of singly to vigintuply alkoxylated trimethylolpropane, triacrylate of singly to vigintuply alkoxylated glycerol, and/or polycrylate of singly to vigintuply alkoxylated pentaerythritol.

10. The process of claim 8, wherein the solvent (b3) comprises a C₂-C₆-alcohol, C₂-C₆-ether, and/or ether-C₂-C₆-alcohol, optionally further comprising water.

11. A security element, comprising:
a flexible substrate;
a primer layer; and
an optionally embossed film;
obtained by the process of claim 1.

12. The security element of claim 11, comprising a black layer, white layer, metallic layer, plasmonic layer, liquid crystalline layer, magnetic layer, fluorescent layer, interference layer, colored layer, IR-absorbing layer, IR-transparent layer, and/or conductive layer.

13. A security document, comprising the security element of claim 11 as a laminate onto the document or embedded as a (windowed) thread into the document or as a window on the document.

14. A primer composition, comprising:
(b1) a polyurethane (A) comprising as synthesis components (b1a) an organic polyisocyanate having a functionality of at least 2, (b1b) a compound comprising an isocyanate-reactive group and a radically polymerizable unsaturated group, (b1c) a photoinitiator comprising an isocyanate-reactive group;
(b2) a polyfunctional polymerizable compound (B);
(b3) a solvent;
wherein a proportion of the solvent is in a range of from 90.0 to 99.5 wt. %, a proportion of the compound (B) and the polyurethane (A) is in a range of from 10.0 to 0.5 wt %, the proportions adding up to 100 wt %.

15. The composition of claim 14, wherein the polyurethane (A) is a compound of formula 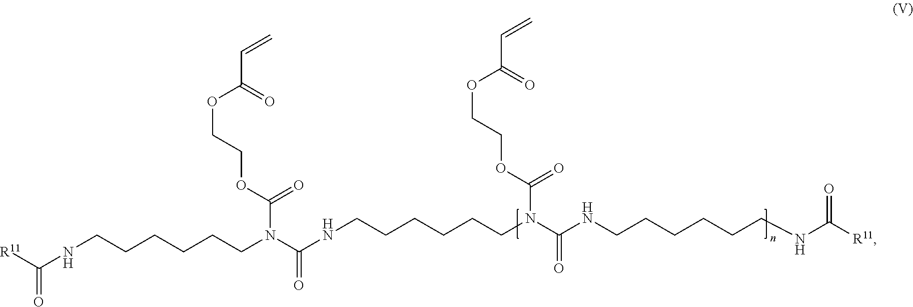
wherein n is a positive number which is on average 1 up to 5, and
is a group of formula 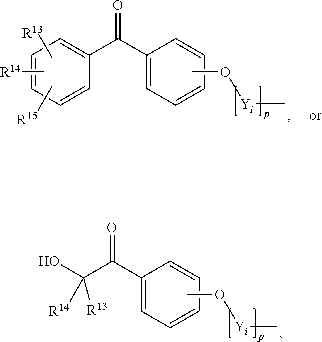
wherein
R¹³, R¹⁴, and R¹⁵ are independently H, an alkyl group comprising 1 to 4 carbon atoms, or an alkyloxy group comprising 1 to 4 carbon atoms,
p is 0 or an integer in a range of from 1 to 10, and
Yᵢ for i=1 to p is independently —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group of —CH₂—CH₂—O—, —CH₂—CH(CH₃)—O—, or —CH(CH₃)—CH₂—O—, in which Ph is phenyl and Vin is vinyl.

16. The composition of claim 14, wherein the polymerizable compound (B) comprises 1,2-propanediol diacrylate, 1,3-propanediol diacrylate, dipropylene glycol diacrylate, tripropylene glycol diacrylate, polyethylene glycol diacrylate, polyethylene glycol dimethacrylate, trimethylolpropane triacrylate, ditrimethylol tetracrylate, dipentaerythritol hexaacrylate, triacrylate of singly to vigintuply alkoxylated trimethylolpropane, triacylate of singly to vigintuply alkoxylated glycerol, and/or polycrylate of singly to vigintuply alkoxylated pentaerythritol.

17. The composition of claim 14, wherein the solvent (b3) comprises a C₁-C₆-alcohol and/or ether-C₁-C₆-alcohol.

18. A process for improving adherence of a curable layer to a flexible substrate, comprising:
priming the flexible substrate with the primer composition of claim 14 to obtain a primed substrate; then
adhering the curable layer optionally in uncured form, to the primed substrate.
